(19) United States
(12) Patent Application Publication
(10) Pub. No.: US 2023/0134619 A1
(43) Pub. Date: May 4, 2023

(54) METHOD OF GENERATING A HASH-BASED MESSAGE AUTHENTICATION CODE

(71) Applicant: nChain Licensing AG, Zug (CH)

(72) Inventors: Craig Steven WRIGHT, London (GB); Owen VAUGHAN, London (GB); Michaella PETTIT, London (GB)

(21) Appl. No.: 17/908,833

(22) PCT Filed: Feb. 4, 2021
(86) PCT No.: PCT/IB2021/050892

§ 371 Date: Sep. 1, 2022

(30) Foreign Application Priority Data
Mar. 4, 2020 (GB) 2003128.2

(51) Int. Cl. H04L 9/00; H04L 9/32; H04L 9/30

(52) U.S. Cl. CPC H04L 9/50; H04L 9/3242; H04L 9/30

(57) ABSTRACT

A computer-implemented method of generating a hash-based message authentication code, HMAC, of a message using blockchain transactions. The method is performed by a first party and comprises generating an output script of a first blockchain transaction. The output script comprises a HMAC script configured to, when executed alongside an input script of a second blockchain transaction, generate the HMAC of the message based on an input value included in the input script of the second blockchain transaction. The method further comprises causing the first blockchain transaction to be transmitted to one or more nodes of a blockchain network for inclusion in the blockchain.

### CROSS REFERENCE TO RELATED APPLICATIONS

This application is the U.S. National Stage of International Application No. PCT/IB2021/050892 filed on Feb. 4, 2021, which claims the benefit of United Kingdom Patent Application No. 2003128.2, filed on Mar. 4, 2020, the contents of which are incorporated herein by reference in their entireties.

### TECHNICAL FIELD

The present disclosure relates to a method of using blockchain transactions to generate a hash-based message authentication code (HMAC) of a message.

### BACKGROUND

A blockchain refers to a form of distributed data structure, wherein a duplicate copy of the blockchain is maintained at each of a plurality of nodes in a peer-to-peer (P2P) network. The blockchain comprises a chain of blocks of data, wherein each block comprises one or more transactions. Each transaction may point back to a preceding transaction in a sequence which may span one or more blocks. Transactions can be submitted to the network to be included in new blocks. New blocks are created by a process known as “mining”, which involves each of a plurality of mining nodes competing to perform “proof-of-work”, i.e. solving a cryptographic puzzle based on a pool of the pending transactions waiting to be included in blocks.

Conventionally the transactions in the blockchain are used to convey a digital asset, i.e. data acting as a store of value. However, a blockchain can also be exploited in order to layer additional functionality on top of the blockchain. For instance, blockchain protocols may allow for storage of additional user data in an output of a transaction. Modern blockchains are increasing the maximum data capacity that can be stored within a single transaction, enabling more complex data to be incorporated. For instance this may be used to store an electronic document in the blockchain, or even audio or video data.

Each node in the network can have any one, two or all of three roles: forwarding, mining and storage. Forwarding nodes propagate transactions throughout the nodes of the network. Mining nodes perform the mining of transactions into blocks. Storage nodes each store their own copy of the mined blocks of the blockchain. In order to have a transaction recorded in the blockchain, a party sends the transaction to one of the nodes of the network to be propagated. Mining nodes which receive the transaction may race to mine the transaction into a new block. Each node is configured to respect the same node protocol, which will include one or more conditions for a transaction to be valid. Invalid transactions will not be propagated nor mined into blocks. Assuming the transaction is validated and thereby accepted onto the blockchain, then the transaction (including any user data) will thus remain stored at each of the nodes in the P2P network as an immutable public record.

The miner who successfully solved the proof-of-work puzzle to create the latest block is typically rewarded with a new transaction called a “generation transaction” which generates a new amount of the digital asset. The proof-of work incentivises miners not to cheat the system by including double-spending transactions in their blocks, since it requires a large amount of compute resource to mine a block, and a block that includes an attempt to double spend is likely not be accepted by other nodes.

In an “output-based” model (sometimes referred to as a UTXO-based model), the data structure of a given transaction comprises one or more inputs and one or more outputs. Any spendable output comprises an element specifying an amount of the digital asset, sometimes referred to as a UTXO (“unspent transaction output”). The output may further comprise a locking script specifying a condition for redeeming the output. Each input comprises a pointer to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the P2P network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it nor include it for mining into a block to be recorded in the blockchain.

A hash-based message authentication code (HMAC), sometimes also referred to as a keyed-hash message authentication code, is a type of message authentication code (MAC) involving a cryptographic hash function and a secret cryptographic key.

A HMAC of a message is generated using a message authentication algorithm which validates the integrity of a received message. Assume that a first party (e.g. Alice) would like to send a message to a second party (e.g. Bob). Alice encrypts the message and then sends Bob the encrypted message alongside a HMAC of the message (which may be signed with a shared secret). If Bob can verify that the HMAC sent to him by Alice is equivalent to a local calculation of the HMAC, he knows that the message has not been compromised in transmission and that it has indeed been sent by Alice.

The HMAC of a ciphertext message, given an HMAC key K_{HMAC} is defined as

HMAC(K_{HMAC},ciphertext)=H((K_{HMAC}⊕opad)∥H((K_{HMAC}⊕ipad)∥ciphertext)),

where H is a hash function, or some combination of hash functions. Additionally, opad and ipad are constants in hexadecimal representation whose length depends on the length of the input of the hash function (also called the block size). The opad and ipad were defined in the original paper that introduced HMAC (M. Bellare, R. Canetti and H. Krawczyk, “Keying hash functions for message authentication”, in Annual international cryptology conference, 1996, pp. 1-15). The ipad is defined to be the byte 0x36 and the opad is defined to be the byte 0x5c, both of which are repeated to match the block size of the given hash function H. For example, with SHA-256, the input size is 512 bits, so the paddings are repeated 64 times. The opad and ipad were chosen arbitrarily, and the only constraint behind the choice was that they are not the same constant. The inclusion of these paddings is to make the HMAC function more cryptographically secure than its predecessors.

### SUMMARY

One of the main security features of the blockchain is the computational infeasibility of calculating a private key, given a public key. The private key is used as a means to control an output of a blockchain transaction, is difficult to bypass, and may be linked to an identity of a party possessing the private key. It is this (i.e. the difficulty in obtaining a private key from the public key alone), that allows locked outputs of a given transaction to be unlocked only by the party possessing a private-public key pair. In order to unlock a locking script (also called an output script) that is locked with the hash of some public key, one must provide a signature that is created using the corresponding private key. The fields in the transaction that correspond to these locking and unlocking scripts are written in a scripting language. For example, one particular blockchain protocol uses a specific language called ‘Script’ (capital S).

Typically, a HMAC of a message is calculated by a sending party (e.g. Alice) and transmitted, along with the message itself, to a receiving party (e.g. Bob). It would be desirable to generate a HMAC of the message using the blockchain, i.e. using transactions of the blockchain. This would allow the HMAC to be permanently and immutably recorded on the blockchain for any party to check and verify.

According to one aspect disclosed herein, there is provided a computer-implemented method of generating a hash-based message authentication code, HMAC, of a message using blockchain transactions, wherein the method is performed by a first party and comprises: generating an output script of a first blockchain transaction, wherein the output script comprises a HMAC script configured to, when executed alongside an input script of a second blockchain transaction, generate the HMAC of the message based on an input value included in the input script of the second blockchain transaction; and causing the first blockchain transaction to be transmitted to one or more nodes of a blockchain network for inclusion in the blockchain.

The first party generates the output script of the first transaction. The first party may also generate the first transaction, or alternatively, the first party may obtain the first transaction, i.e. the first transaction may be a transaction template to which the first party may add an additional output (and, in some examples, an additional input). The output script (also referred to below as a locking script) comprises a portion of script referred to as a “HMAC script”. Note that this is merely a label for a portion of the output script which is configured to perform a defined function. The output script may comprise one or more additional portions of script other than the HMAC script. The first party generates the HMAC script such that, when the HMAC script is provided with an input from an input script of a second (i.e. later) transaction, the HMAC script will generate a HMAC of a message. The first party then transmits the first transaction to the blockchain network, or forwards the first transaction to a party for transmitting to the blockchain network. Note that at the time the first blockchain is generated and transmitted, the second transaction has not been transmitted to the blockchain network.

The first party may generate the HMAC script such that it is configured to require a specific input (included in the input script of the second transaction) in order to generate the HMAC. For instance, the HMAC script may be configured to require the input to be a (secret) HMAC key. Alternatively, the input may be required to be the message itself, i.e. the HMAC script is configured to take any message as an input and generate the HMAC of that message. As another alternative, and to preserve privacy of the message, the HMAC script may be configured to require the input to be a hash of at least the message.

The present invention generates the HMAC in script, such that calculations of HMAC functions can be completed using the output (locking) and input (unlocking) fields of blockchain transaction. The script may be written in the Script language, which is made up of predefined functions called opcodes.

The HMAC can also be used in a similar way to a normal P2PKH script where one must provide a signature from a private key in order to unlock an output of a transaction. By using the HMAC, one can ‘lock’ an output that can only be unlocked with the right preimage to the HMAC.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of another system for implementing a blockchain,

FIG. 4A is a schematic block diagram of a client application,

FIG. 4B is a schematic mock-up of an example user interface that may be presented by the client application of FIG. 4A,

FIG. 5 is a schematic block diagram of some node software for processing transactions,

FIG. 6 schematically illustrates a system for generating a HMAC of a message using transactions of a blockchain,

FIG. 7 schematically illustrates a system for generating a public key using transactions of a blockchain,

FIG. 8 schematically illustrates a hierarchical deterministic set of keys,

FIG. 9 is an example script for converting to a binary representation,

FIG. 10 is an example script for performing a point scalar multiplication,

FIG. 11 is an example script for performing an inverse modulo calculation,

FIG. 12 is an example script for performing a point addition of two different points,

FIG. 13 is an example script for performing a point addition of two same points,

FIG. 14 is an example script for performing a point addition of two points, and

FIG. 15 is an example script for converting data into a compressed key format.

### DETAILED DESCRIPTION OF EMBODIMENTS

### Example System Overview

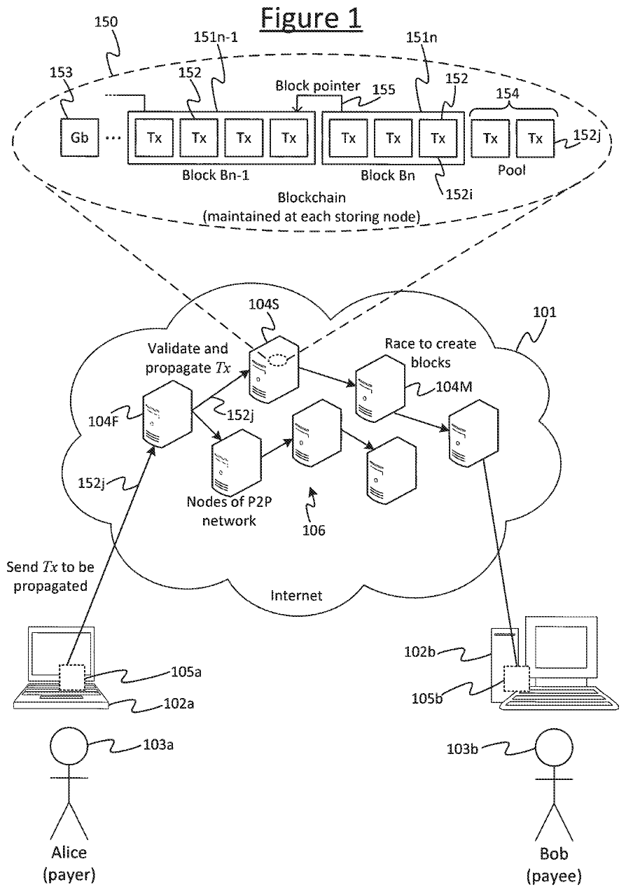

FIG. 1 shows an example system 100 for implementing a blockchain 150. The system 100 comprises a packet-switched network 101, typically a wide-area internetwork such as the Internet. The packet-switched network 101 comprises a plurality of nodes 104 arranged to form a peer-to-peer (P2P) overlay network 106 within the packet-switched network 101. Each node 104 comprises computer equipment of a peers, with different ones of the nodes 104 belonging to different peers. Each node 104 comprises processing apparatus comprising one or more processors, e.g. one or more central processing units (CPUs), accelerator processors, application specific processors and/or field programmable gate arrays (FPGAs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of nodes in the P2P network 160. Each block 151 in the chain comprises one or more transactions 152, wherein a transaction in this context refers to a kind of data structure. The nature of the data structure will depend on the type of transaction protocol used as part of a transaction model or scheme. A given blockchain will typically use one particular transaction protocol throughout. In one common type of transaction protocol, the data structure of each transaction 152 comprises at least one input and at least one output. Each output specifies an amount representing a quantity of a digital asset belonging to a user 103 to whom the output is cryptographically locked (requiring a signature of that user in order to be unlocked and thereby redeemed or spent). Each input points back to the output of a preceding transaction 152, thereby linking the transactions.

At least some of the nodes 104 take on the role of forwarding nodes 104F which forward and thereby propagate transactions 152. At least some of the nodes 104 take on the role of miners 104M which mine blocks 151. At least some of the nodes 104 take on the role of storage nodes 104S (sometimes also called “full-copy” nodes), each of which stores a respective copy of the same blockchain 150 in their respective memory. Each miner node 104M also maintains a pool 154 of transactions 152 waiting to be mined into blocks 151. A given node 104 may be a forwarding node 104, miner 104M, storage node 104S or any combination of two or all of these.

In a given present transaction 152j, the (or each) input comprises a pointer referencing the output of a preceding transaction 152i in the sequence of transactions, specifying that this output is to be redeemed or “spent” in the present transaction 152j. In general, the preceding transaction could be any transaction in the pool 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

The input of the present transaction 152j also comprises the signature of the user 103a to whom the output of the preceding transaction 152i is locked. In turn, the output of the present transaction 152j can be cryptographically locked to a new user 103b. The present transaction 152j can thus transfer the amount defined in the input of the preceding transaction 152i to the new user 103b as defined in the output of the present transaction 152j. In some cases a transaction 152 may have multiple outputs to split the input amount between multiple users (one of whom could be the original user 103a in order to give change). In some cases a transaction can also have multiple inputs to gather together the amounts from multiple outputs of one or more preceding transactions, and redistribute to one or more outputs of the current transaction.

The above may be referred to as an “output-based” transaction protocol, sometimes also referred to as an unspent transaction output (UTXO) type protocol (where the outputs are referred to as UTXOs). A user's total balance is not defined in any one number stored in the blockchain, and instead the user needs a special “wallet” application 105 to collate the values of all the UTXOs of that user which are scattered throughout many different transactions 152 in the blockchain 151.

An alternative type of transaction protocol may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored by the miners separate to the blockchain and is updated constantly. In such a system, transactions are ordered using a running transaction tally of the account (also called the “position”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

With either type of transaction protocol, when a user 103 wishes to enact a new transaction 152j, then he/she sends the new transaction from his/her computer terminal 102 to one of the nodes 104 of the P2P validation network 106 (which nowadays are typically servers or data centres, but could in principle be other user terminals). This node 104 checks whether the transaction is valid according to a node protocol which is applied at each of the nodes 104. The details of the node protocol will correspond to the type of transaction protocol being used in the blockchain 150 in question, together forming the overall transaction model. The node protocol typically requires the node 104 to check that the cryptographic signature in the new transaction 152j matches the expected signature, which depends on the previous transaction 152i in an ordered sequence of transactions 152. In an output-based case, this may comprise checking that the cryptographic signature of the user included in the input of the new transaction 152j matches a condition defined in the output of the preceding transaction 152i which the new transaction spends, wherein this condition typically comprises at least checking that the cryptographic signature in the input of the new transaction 152j unlocks the output of the previous transaction 152i to which the input of the new transaction points. In some transaction protocols the condition may be at least partially defined by a custom script included in the input and/or output. Alternatively it could simply be a fixed by the node protocol alone, or it could be due to a combination of these. Either way, if the new transaction 152j is valid, the current node forwards it to one or more others of the nodes 104 in the P2P network 106. At least some of these nodes 104 also act as forwarding nodes 104F, applying the same test according to the same node protocol, and so forward the new transaction 152j on to one or more further nodes 104, and so forth. In this way the new transaction is propagated throughout the network of nodes 104.

In an output-based model, the definition of whether a given output (e.g. UTXO) is spent is whether it has yet been validly redeemed by the input of another, onward transaction 152j according to the node protocol. Another condition for a transaction to be valid is that the output of the preceding transaction 152i which it attempts to spend or redeem has not already been spent/redeemed by another valid transaction. Again if not valid, the transaction 152j will not be propagated or recorded in the blockchain. This guards against double-spending whereby the spender tries to spend the output of the same transaction more than once. An account-based model on the other hand guards against double-spending by maintaining an account balance. Because again there is a defined order of transactions, the account balance has a single defined state at any one time.

In addition to validation, at least some of the nodes 104M also race to be the first to create blocks of transactions in a process known as mining, which is underpinned by “proof of work”. At a mining node 104M, new transactions are added to a pool of valid transactions that have not yet appeared in a block. The miners then race to assemble a new valid block 151 of transactions 152 from the pool of transactions 154 by attempting to solve a cryptographic puzzle. Typically this comprises searching for a “nonce” value such that when the nonce is concatenated with the pool of transactions 154 and hashed, then the output of the hash meets a predetermined condition. E.g. the predetermined condition may be that the output of the hash has a certain predefined number of leading zeros. A property of a hash function is that it has an unpredictable output with respect to its input. Therefore this search can only be performed by brute force, thus consuming a substantive amount of processing resource at each node 104M that is trying to solve the puzzle.

The first miner node 104M to solve the puzzle announces this to the network 106, providing the solution as proof which can then be easily checked by the other nodes 104 in the network (once given the solution to a hash it is straightforward to check that it causes the output of the hash to meet the condition). The pool of transactions 154 for which the winner solved the puzzle then becomes recorded as a new block 151 in the blockchain 150 by at least some of the nodes 104 acting as storage nodes 104S, based on having checked the winner's announced solution at each such node. A block pointer 155 is also assigned to the new block 151n pointing back to the previously created block 151n-1 in the chain. The proof-of-work helps reduce the risk of double spending since it takes a large amount of effort to create a new block 151, and as any block containing a double spend is likely to be rejected by other nodes 104, mining nodes 104M are incentivised not to allow double spends to be included in their blocks. Once created, the block 151 cannot be modified since it is recognized and maintained at each of the storing nodes 104S in the P2P network 106 according to the same protocol. The block pointer 155 also imposes a sequential order to the blocks 151. Since the transactions 152 are recorded in the ordered blocks at each storage node 104S in a P2P network 106, this therefore provides an immutable public ledger of the transactions.

Note that different miners 104M racing to solve the puzzle at any given time may be doing so based on different snapshots of the unmined transaction pool 154 at any given time, depending on when they started searching for a solution. Whoever solves their respective puzzle first defines which transactions 152 are included in the next new block 151n, and the current pool 154 of unmined transactions is updated. The miners 104M then continue to race to create a block from the newly defined outstanding pool 154, and so forth. A protocol also exists for resolving any “fork” that may arise, which is where two miners 104M solve their puzzle within a very short time of one another such that a conflicting view of the blockchain gets propagated. In short, whichever prong of the fork grows the longest becomes the definitive blockchain 150.

In most blockchains the winning miner 104M is automatically rewarded with a special kind of new transaction which creates a new quantity of the digital asset out of nowhere (as opposed to normal transactions which transfer an amount of the digital asset from one user to another). Hence the winning node is said to have “mined” a quantity of the digital asset. This special type of transaction is sometime referred to as a “generation” transaction. It automatically forms part of the new block 151n. This reward gives an incentive for the miners 104M to participate in the proof-of-work race. Often a regular (non-generation) transaction 152 will also specify an additional transaction fee in one of its outputs, to further reward the winning miner 104M that created the block 151n in which that transaction was included.

Due to the computational resource involved in mining, typically at least each of the miner nodes 104M takes the form of a server comprising one or more physical server units, or even whole a data centre. Each forwarding node 104M and/or storage node 104S may also take the form of a server or data centre. However in principle any given node 104 could take the form of a user terminal or a group of user terminals networked together.

The memory of each node 104 stores software configured to run on the processing apparatus of the node 104 in order to perform its respective role or roles and handle transactions 152 in accordance with the node protocol. It will be understood that any action attributed herein to a node 104 may be performed by the software run on the processing apparatus of the respective computer equipment. The node software may be implemented in one or more applications at the application layer, or a lower layer such as the operating system layer or a protocol layer, or any combination of these. Also, the term “blockchain” as used herein is a generic term that refers to the kind of technology in general, and does not limit to any particular proprietary blockchain, protocol or service.

Also connected to the network 101 is the computer equipment 102 of each of a plurality of parties 103 in the role of consuming users. These act as payers and payees in transactions but do not necessarily participate in mining or propagating transactions on behalf of other parties. They do not necessarily run the mining protocol. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective user party 103 to create, sign and send transactions 152 to be propagated throughout the network of nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the forwarding nodes 104F of the P2P network 106. This enables the wallet function of the client 105 to send transactions 152 to the network 106. The client 105 is also able to contact one, some or all of the storage nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. Each node 104 runs software configured to validate transactions 152 according to a node protocol, and in the case of the forwarding nodes 104F to forward transactions 152 in order to propagate them throughout the network 106. The transaction protocol and node protocol correspond to one another, and a given transaction protocol goes with a given node protocol, together implementing a given transaction model. The same transaction protocol is used for all transactions 152 in the blockchain 150 (though the transaction protocol may allow different subtypes of transaction within it). The same node protocol is used by all the nodes 104 in the network 106 (though it many handle different subtypes of transaction differently in accordance with the rules defined for that subtype, and also different nodes may take on different roles and hence implement different corresponding aspects of the protocol).

As mentioned, the blockchain 150 comprises a chain of blocks 151, wherein each block 151 comprises a set of one or more transactions 152 that have been created by a proof-of-work process as discussed previously. Each block 151 also comprises a block pointer 155 pointing back to the previously created block 151 in the chain so as to define a sequential order to the blocks 151. The blockchain 150 also comprises a pool of valid transactions 154 waiting to be included in a new block by the proof-of-work process. Each transaction 152 (other than a generation transaction) comprises a pointer back to a previous transaction so as to define an order to sequences of transactions (N.B. sequences of transactions 152 are allowed to branch). The chain of blocks 151 goes all the way back to a genesis block (Gb) 153 which was the first block in the chain. One or more original transactions 152 early on in the chain 150 pointed to the genesis block 153 rather than a preceding transaction.

When a given party 103, say Alice, wishes to send a new transaction 152j to be included in the blockchain 150, then she formulates the new transaction in accordance with the relevant transaction protocol (using the wallet function in her client application 105). She then sends the transaction 152 from the client application 105 to one of the one or more forwarding nodes 104F to which she is connected. E.g. this could be the forwarding node 104F that is nearest or best connected to Alice's computer 102. When any given node 104 receives a new transaction 152j, it handles it in accordance with the node protocol and its respective role. This comprises first checking whether the newly received transaction 152j meets a certain condition for being “valid”, examples of which will be discussed in more detail shortly. In some transaction protocols, the condition for validation may be configurable on a per-transaction basis by scripts included in the transactions 152. Alternatively the condition could simply be a built-in feature of the node protocol, or be defined by a combination of the script and the node protocol.

On condition that the newly received transaction 152j passes the test for being deemed valid (i.e. on condition that it is “validated”), any storage node 104S that receives the transaction 152j will add the new validated transaction 152 to the pool 154 in the copy of the blockchain 150 maintained at that node 104S. Further, any forwarding node 104F that receives the transaction 152j will propagate the validated transaction 152 onward to one or more other nodes 104 in the P2P network 106. Since each forwarding node 104F applies the same protocol, then assuming the transaction 152j is valid, this means it will soon be propagated throughout the whole P2P network 106.

Once admitted to the pool 154 in the copy of the blockchain 150 maintained at one or more storage nodes 104, then miner nodes 104M will start competing to solve the proof-of-work puzzle on the latest version of the pool 154 including the new transaction 152 (other miners 104M may still be trying to solve the puzzle based on the old view of the pool 154, but whoever gets there first will define where the next new block 151 ends and the new pool 154 starts, and eventually someone will solve the puzzle for a part of the pool 154 which includes Alice's transaction 152j). Once the proof-of-work has been done for the pool 154 including the new transaction 152j, it immutably becomes part of one of the blocks 151 in the blockchain 150. Each transaction 152 comprises a pointer back to an earlier transaction, so the order of the transactions is also immutably recorded.

Different nodes 104 may receive different instances of a given transaction first and therefore have conflicting views of which instance is ‘valid’ before one instance is mined into a block 150, at which point all nodes 104 agree that the mined instance is the only valid instance. If a node 104 accepts one instance as valid, and then discovers that a second instance has been recorded in the blockchain 150 then that node 104 must accept this and will discard (i.e. treat as invalid) the unmined instance which it had initially accepted.

### UTXO-Based Model

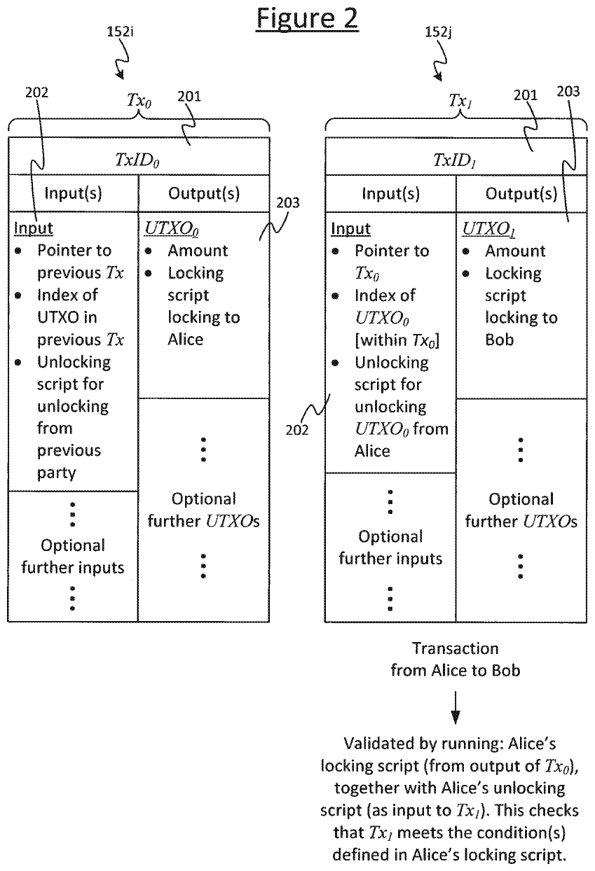

FIG. 2 illustrates an example transaction protocol. This is an example of an UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this not limiting to all possible embodiments.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO specifies an amount of a digital asset. It may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the miners 104M.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just an arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The preceding transaction Tx₀ may already have been validated and included in the blockchain 150 at the time when Alice creates her new transaction Tx₁, or at least by the time she sends it to the network 106. It may already have been included in one of the blocks 151 at that time, or it may be still waiting in the pool 154 in which case it will soon be included in a new block 151. Alternatively Tx₀ and Tx₁ could be created and sent to the network 102 together, or Tx₀ could even be sent after Tx₁ if the node protocol allows for buffering “orphan” transactions. The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given node 104. Nevertheless, a subsequent transaction (the descendent transaction or “child”) which points to a preceding transaction (the antecedent transaction or “parent”) will not be validated until and unless the parent transaction is validated. A child that arrives at a node 104 before its parent is considered an orphan. It may be discarded or buffered for a certain time to wait for the parent, depending on the node protocol and/or miner behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed. Typically the locking script locks the amount to a particular party (the beneficiary of the transaction in which it is included). I.e. the locking script defines an unlocking condition, typically comprising a condition that the unlocking script in the input of the subsequent transaction comprises the cryptographic signature of the party to whom the preceding transaction is locked.

The locking script (aka scriptPubKey) is a piece of code written in the domain specific language recognized by the node protocol. A particular example of such a language is called “Script” (capital S). The locking script specifies what information is required to spend a transaction output 203, for example the requirement of Alice's signature. Unlocking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). What data (or “message”) needs to be signed by Alice to provide a valid signature may be defined by the locking script, or by the node protocol, or by a combination of these.

When the new transaction Tx₁ arrives at a node 104, the node applies the node protocol. This comprises running the locking script and unlocking script together to check whether the unlocking script meets the condition defined in the locking script (where this condition may comprise one or more criteria). In embodiments this involves concatenating the two scripts:

<Sig P_{A}> <P_{A}>∥[Checksig P_{A}]

where “∥” represents a concatenation and “< . . . >” means place the data on the stack, and “[ . . . ]” is a function comprised by the unlocking script (in this example a stack-based language). Equivalently the scripts may be run one after the other, with a common stack, rather than concatenating the scripts. Either way, when run together, the scripts use the public key P_{A} of Alice, as included in the locking script in the output of Tx₀, to authenticate that the locking script in the input of Tx₁ contains the signature of Alice signing the expected portion of data. The expected portion of data itself (the “message”) also needs to be included in Tx₀ order to perform this authentication. In embodiments the signed data comprises the whole of Tx₀ (so a separate element does to need to be included specifying the signed portion of data in the clear, as it is already inherently present).

The details of authentication by public-private cryptography will be familiar to a person skilled in the art. Basically, if Alice has signed a message by encrypting it with her private key, then given Alice's public key and the message in the clear (the unencrypted message), another entity such as a node 104 is able to authenticate that the encrypted version of the message must have been signed by Alice. Signing typically comprises hashing the message, signing the hash, and tagging this onto the clear version of the message as a signature, thus enabling any holder of the public key to authenticate the signature. Note therefore that any reference herein to signing a particular piece of data or part of a transaction, or such like, can in embodiments mean signing a hash of that piece of data or part of the transaction.

If the unlocking script in Tx₁ meets the one or more conditions specified in the locking script of Tx₀ (so in the example shown, if Alice's signature is provided in Tx₁ and authenticated), then the node 104 deems Tx₁ valid. If it is a mining node 104M, this means it will add it to the pool of transactions 154 awaiting proof-of-work. If it is a forwarding node 104F, it will forward the transaction Tx₁ to one or more other nodes 104 in the network 106, so that it will be propagated throughout the network. Once Tx₁ has been validated and included in the blockchain 150, this defines UTXO₀ from Tx₀ as spent. Note that Tx₁ can only be valid if it spends an unspent transaction output 203. If it attempts to spend an output that has already been spent by another transaction 152, then Tx₁ will be invalid even if all the other conditions are met. Hence the node 104 also needs to check whether the referenced UTXO in the preceding transaction Tx₀ is already spent (has already formed a valid input to another valid transaction). This is one reason why it is important for the blockchain 150 to impose a defined order on the transactions 152. In practice a given node 104 may maintain a separate database marking which UTXOs 203 in which transactions 152 have been spent, but ultimately what defines whether a UTXO has been spent is whether it has already formed a valid input to another valid transaction in the blockchain 150.

If the total amount specified in all the outputs 203 of a given transaction 152 is greater than the total amount pointed to by all its inputs 202, this is another basis for invalidity in most transaction models. Therefore such transactions will not be propagated nor mined into blocks 151.

Note that in UTXO-based transaction models, a given UTXO needs to be spent as a whole. It cannot “leave behind” a fraction of the amount defined in the UTXO as spent while another fraction is spent. However the amount from the UTXO can be split between multiple outputs of the next transaction. E.g. the amount defined in UTXO₀ in Tx₀ can be split between multiple UTXOs in Tx₁. Hence if Alice does not want to give Bob all of the amount defined in UTXO₀, she can use the remainder to give herself change in a second output of Tx₁, or pay another party.

In practice Alice will also usually need to include a fee for the winning miner, because nowadays the reward of the generation transaction alone is not typically sufficient to motivate mining. If Alice does not include a fee for the miner, Tx₀ will likely be rejected by the miner nodes 104M, and hence although technically valid, it will still not be propagated and included in the blockchain 150 (the miner protocol does not force miners 104M to accept transactions 152 if they don't want). In some protocols, the mining fee does not require its own separate output 203 (i.e. does not need a separate UTXO). Instead any different between the total amount pointed to by the input(s) 202 and the total amount of specified in the output(s) 203 of a given transaction 152 is automatically given to the winning miner 104. E.g. say a pointer to UTXO₀ is the only input to Tx₁, and Tx₁ has only one output UTXO₁. If the amount of the digital asset specified in UTXO₀ is greater than the amount specified in UTXO₁, then the difference automatically goes to the winning miner 104M. Alternatively or additionally however, it is not necessarily excluded that a miner fee could be specified explicitly in its own one of the UTXOs 203 of the transaction 152.

Alice and Bob's digital assets consist of the unspent UTXOs locked to them in any transactions 152 anywhere in the blockchain 150. Hence typically, the assets of a given party 103 are scattered throughout the UTXOs of various transactions 152 throughout the blockchain 150. There is no one number stored anywhere in the blockchain 150 that defines the total balance of a given party 103. It is the role of the wallet function in the client application 105 to collate together the values of all the various UTXOs which are locked to the respective party and have not yet been spent in another onward transaction. It can do this by querying the copy of the blockchain 150 as stored at any of the storage nodes 104S, e.g. the storage node 104S that is closest or best connected to the respective party's computer equipment 102.

Note that the script code is often represented schematically (i.e. not the exact language). For example, one may write [Checksig P_{A}] to mean [Checksig P_{A}]=OP_DUP OP_HASH160<H(P_{A})> OP_EQUALVERIFY OP_CHECKSIG. “OP_. . . ” refers to a particular opcode of the Script language. OP_CHECKSIG (also called “Checksig”) is a Script opcode that takes two inputs (signature and public key) and verifies the signature's validity using the Elliptic Curve Digital Signature Algorithm (ECDSA). At runtime, any occurrences of signature (‘sig’) are removed from the script but additional requirements, such as a hash puzzle, remain in the transaction verified by the ‘sig’ input. As another example, OP_RETURN is an opcode of the Script language for creating an unspendable output of a transaction that can store metadata within the transaction, and thereby record the metadata immutably in the blockchain 150. E.g. the metadata could comprise a document which it is desired to store in the blockchain.

The signature P_{A} is a digital signature. In embodiments this is based on the ECDSA using the elliptic curve secp256k1. A digital signature signs a particular piece of data. In embodiments, for a given transaction the signature will sign part of the transaction input, and all or part of the transaction output. The particular parts of the outputs it signs depends on the SIGHASH flag. The SIGHASH flag is a 4-byte code included at the end of a signature to select which outputs are signed (and thus fixed at the time of signing).

The locking script is sometimes called “scriptPubKey” referring to the fact that it comprises the public key of the party to whom the respective transaction is locked. The unlocking script is sometimes called “scriptSig” referring to the fact that it supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### Optional Side Channel

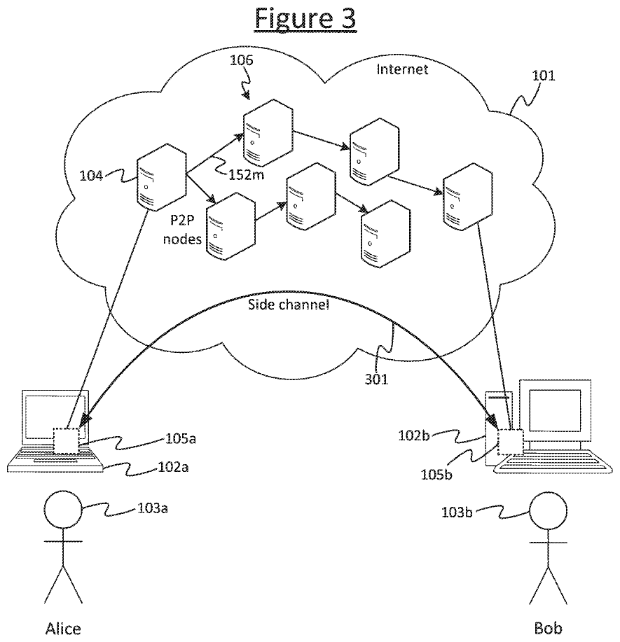

FIG. 3 shows a further system 100 for implementing a blockchain 150. The system 100 is substantially the same as that described in relation to FIG. 1 except that additional communication functionality is involved. The client application on each of Alice and Bob's computer equipment 102a, 120b, respectively, comprises additional communication functionality. That is, it enables Alice 103a to establish a separate side channel 301 with Bob 103b (at the instigation of either party or a third party). The side channel 301 enables exchange of data separately from the P2P network. Such communication is sometimes referred to as “off-chain”. For instance this may be used to exchange a transaction 152 between Alice and Bob without the transaction (yet) being published onto the network P2P 106 or making its way onto the chain 150, until one of the parties chooses to broadcast it to the network 106. Alternatively or additionally, the side channel 301 may be used to exchange any other transaction related data, such as keys, negotiated amounts or terms, data content, etc.

The side channel 301 may be established via the same packet-switched network 101 as the P2P overlay network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 301 as referred to anywhere herein may comprise any one or more links via one or more networking technologies or communication media for exchanging data “off-chain”, i.e. separately from the P2P overlay network 106. Where more than one link is used, then the bundle or collection of off-chain links as a whole may be referred to as the side channel 301. Note therefore that if it is said that Alice and Bob exchange certain pieces of information or data, or such like, over the side channel 301, then this does not necessarily imply all these pieces of data have to be send over exactly the same link or even the same type of network.

### Client Software

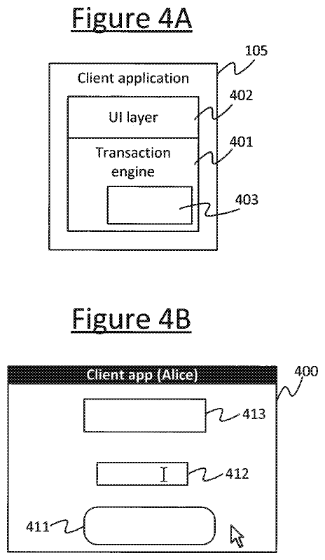

FIG. 4A illustrates an example implementation of the client application 105 for implementing embodiments of the presently disclosed scheme. The client application 105 comprises a transaction engine 401 and a user interface (UI) layer 402. The transaction engine 401 is configured to implement the underlying transaction-related functionality of the client 105, such as to formulate transactions 152, receive and/or send transactions and/or other data over the side channel 301, and/or send transactions to be propagated through the P2P network 106, in accordance with the schemes discussed above and as discussed in further detail shortly. In accordance with embodiments disclosed herein, the transaction engine 401 of each client 105 comprises a function 403 configured to generate the output script of a transaction, wherein the output script comprises the HMAC script. The function 403 may be configured to generate the HMAC script based on user input(s), e.g. to include the user input(s), such as the HMAC key or the message.

The UI layer 402 is configured to render a user interface via a user input/output (I/O) means of the respective user's computer equipment 102, including outputting information to the respective user 103 via a user output means of the equipment 102, and receiving inputs back from the respective user 103 via a user input means of the equipment 102. For example the user output means could comprise one or more display screens (touch or non-touch screen) for providing a visual output, one or more speakers for providing an audio output, and/or one or more haptic output devices for providing a tactile output, etc. The user input means could comprise for example the input array of one or more touch screens (the same or different as that/those used for the output means); one or more cursor-based devices such as mouse, trackpad or trackball; one or more microphones and speech or voice recognition algorithms for receiving a speech or vocal input; one or more gesture-based input devices for receiving the input in the form of manual or bodily gestures; or one or more mechanical buttons, switches or joysticks, etc.

Note: whilst the various functionality herein may be described as being integrated into the same client application 105, this is not necessarily limiting and instead they could be implemented in a suite of two or more distinct applications, e.g. one being a plug-in to the other or interfacing via an API (application programming interface). For instance, the functionality of the transaction engine 401 may be implemented in a separate application than the UI layer 402, or the functionality of a given module such as the transaction engine 401 could be split between more than one application. Nor is it excluded that some or all of the described functionality could be implemented at, say, the operating system layer. Where reference is made anywhere herein to a single or given application 105, or such like, it will be appreciated that this is just by way of example, and more generally the described functionality could be implemented in any form of software.

FIG. 4B gives a mock-up of an example of the user interface (UI) 400 which may be rendered by the UI layer 402 of the client application 105a on Alice's equipment 102a. It will be appreciated that a similar UI may be rendered by the client 105b on Bob's equipment 102b, or that of any other party.

By way of illustration FIG. 4B shows the UI 400 from Alice's perspective. The UI 400 may comprise one or more UI elements 411, 412, 413 rendered as distinct UI elements via the user output means.

For example, the UI elements may comprise one or more user-selectable elements 411 which may be, such as different on-screen buttons, or different options in a menu, or such like. The user input means is arranged to enable the user 103 (in this case Alice 103a) to select or otherwise operate one of the options, such as by clicking or touching the UI element on-screen, or speaking a name of the desired option (N.B. the term “manual” as used herein is meant only to contrast against automatic, and does not necessarily limit to the use of the hand or hands). The options enable the user (Alice) to specify the requirements of the HMAC script, e.g. the inputs that the HMAC script is configured to require in order to generate the HMAC.

Alternatively or additionally, the UI elements may comprise one or more data entry fields 412, through which the user can, for example, manually enter the HMAC script, or manually enter parts of the HMAC script, e.g. the ciphertext. These data entry fields are rendered via the user output means, e.g. on-screen, and the data can be entered into the fields through the user input means, e.g. a keyboard or touchscreen. Alternatively the data could be received orally for example based on speech recognition.

Alternatively or additionally, the UI elements may comprise one or more information elements 413 output to output information to the user. E.g. this/these could be rendered on screen or audibly.

It will be appreciated that the particular means of rendering the various UI elements, selecting the options and entering data is not material. The functionality of these UI elements will be discussed in more detail shortly. It will also be appreciated that the UI 400 shown in FIG. 4B is only a schematized mock-up and in practice it may comprise one or more further UI elements, which for conciseness are not illustrated.

### Node Software

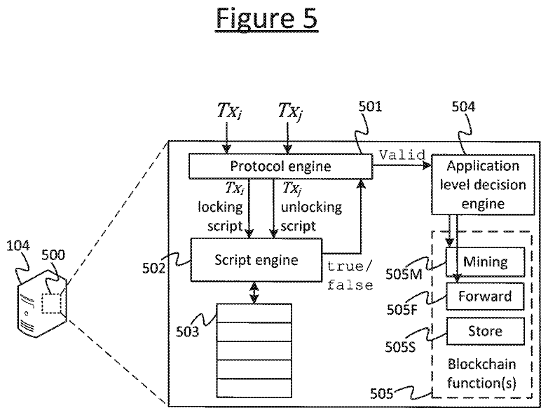

FIG. 5 illustrates an example of the node software 500 that is run on each node 104 of the P2P network 106, in the example of a UTXO- or output-based model. The node software 500 comprises a protocol engine 501, a script engine 502, a stack 503, an application-level decision engine 504, and a set of one or more blockchain-related functional modules 505. At any given node 104, these may include any one, two or all three of: a mining module 505M, a forwarding module 505F and a storing module 505S (depending on the role or roles of the node). The protocol engine 501 is configured to recognize the different fields of a transaction 152 and process them in accordance with the node protocol. When a transaction 152j (Txⱼ) is received having an input pointing to an output (e.g. UTXO) of another, preceding transaction 152i (Txₘ₋₁), then the protocol engine 501 identifies the unlocking script in Txⱼ and passes it to the script engine 502. The protocol engine 501 also identifies and retrieves Txᵢ based on the pointer in the input of Txⱼ. It may retrieve Txᵢ from the respective node's own pool 154 of pending transactions if Txᵢ is not already on the blockchain 150, or from a copy of a block 151 in the blockchain 150 stored at the respective node or another node 104 if Txᵢ is already on the blockchain 150. Either way, the script engine 502 identifies the locking script in the pointed-to output of Txᵢ and passes this to the script engine 502.

The script engine 502 thus has the locking script of Txᵢ and the unlocking script from the corresponding input of Txⱼ. For example, transactions labelled Tx₀ and Tx₁ are illustrated in FIG. 2, but the same could apply for any pair of transactions. The script engine 502 runs the two scripts together as discussed previously, which will include placing data onto and retrieving data from the stack 503 in accordance with the stack-based scripting language being used (e.g. Script).

By running the scripts together, the script engine 502 determines whether or not the unlocking script meets the one or more criteria defined in the locking script—i.e. does it “unlock” the output in which the locking script is included? The script engine 502 returns a result of this determination to the protocol engine 501. If the script engine 502 determines that the unlocking script does meet the one or more criteria specified in the corresponding locking script, then it returns the result “true”. Otherwise it returns the result “false”.

In an output-based model, the result “true” from the script engine 502 is one of the conditions for validity of the transaction. Typically there are also one or more further, protocol-level conditions evaluated by the protocol engine 501 that must be met as well; such as that the total amount of digital asset specified in the output(s) of Txⱼ does not exceed the total amount pointed to by its inputs, and that the pointed-to output of Txᵢ has not already been spent by another valid transaction. The protocol engine 501 evaluates the result from the script engine 502 together with the one or more protocol-level conditions, and only if they are all true does it validate the transaction Txⱼ. The protocol engine 501 outputs an indication of whether the transaction is valid to the application-level decision engine 504. Only on condition that Txⱼ is indeed validated, the decision engine 504 may select to control one or both of the mining module 505M and the forwarding module 505F to perform their respective blockchain-related function in respect of Txⱼ. This may comprise the mining module 505M adding Txⱼ to the node's respective pool 154 for mining into a block 151, and/or the forwarding module 505F forwarding Txⱼ to another node 104 in the P2P network 106. Note however that in embodiments, while the decision engine 504 will not select to forward or mine an invalid transaction, this does not necessarily mean that, conversely, it is obliged to trigger the mining or the forwarding of a valid transaction simply because it is valid. Optionally, in embodiments the application-level decision engine 504 may apply one or more additional conditions before triggering either or both of these functions. E.g. if the node is a mining node 104M, the decision engine may only select to mine the transaction on condition that the transaction is both valid and leaves enough of a mining fee.

Note also that the terms “true” and “false” herein do not necessarily limit to returning a result represented in the form of only a single binary digit (bit), though that is certainly one possible implementation. More generally, “true” can refer to any state indicative of a successful or affirmative outcome, and “false” can refer to any state indicative of an unsuccessful or non-affirmative outcome. For instance in an account-based model (not illustrated in FIG. 5), a result of “true” could be indicated by a combination of an implicit, protocol-level) validation of a signature by the node 104 and an additional affirmative output of a smart contract (the overall result being deemed to signal true if both individual outcomes are true).

### HMAC in Script

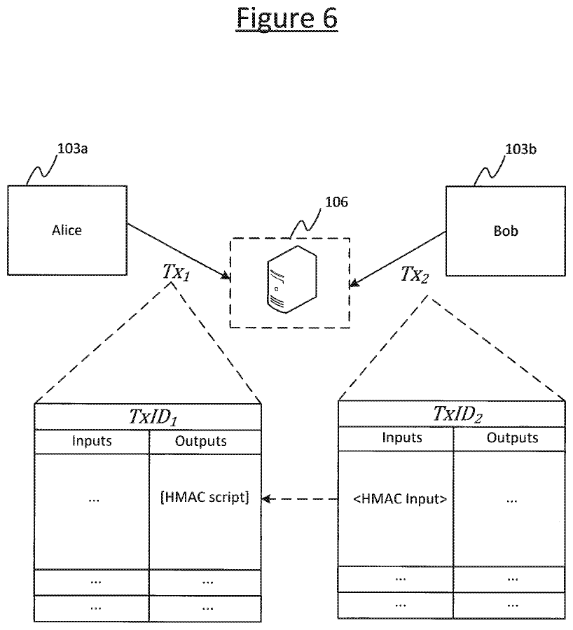

FIG. 6 schematically illustrates a system for generating a HMAC of a message using transactions of a blockchain 150. The system comprises a first party (Alice) 103a and a second party (Bob) 103b, and their respective computer equipment 102a, 102b (not shown). Note that actions described as being performed by Alice 103a or Bob 103b are taken to mean actions performed by the respective computer equipment of Alice or Bob. Alice 103a generates an output script of a first blockchain transaction Tx₁. The output script comprises a HMAC script. The HMAC script is a portion of the output script configured to perform a particular function (which will be described below). The output script is included within an output of the first transaction. The first transaction Tx₁ may comprise one or more additional outputs, each having a respective output script. In some examples, one, some or all of the additional outputs each comprise an output script that includes a respective HMAC script. As is required by the blockchain protocol, the first transaction Tx₁ includes one or more inputs. In the example of FIG. 6, Alice 103a generates the first transaction Tx₁ and transmits the first transaction Tx₁ to the blockchain network 106. If the first transaction Tx₁ is deemed to be a valid transaction it will be recorded in a block 151 of the blockchain 150. In other examples, Alice 103a may transmit the first transaction Tx₁ to a third party (not shown) responsible for transmitting the first transaction Tx₁ to the blockchain network 106, e.g. after adding, to the first transaction Tx₁, one or more additional inputs and/or one or more additional outputs.

Once the first transaction Tx₁ has been transmitted to the blockchain network 106, Bob may generate a second transaction Tx₂ comprising an input. The input of the second transaction Tx₂ references the output of the first transaction Tx₁, i.e. the output comprising the HMAC script, and comprises an input script comprising a HMAC input value. The broken-line arrow in FIG. 6 illustrates the input of the second transaction Tx₂ referencing the output of the first transaction Tx₁. If the first transaction Tx₁ comprises several outputs that each include a respective HMAC script, the input of the second transaction Tx₂ references one of those outputs. When the output script of the first transaction Tx₁ is executed alongside the input script of the second transaction Tx₂, the HMAC script is configured to operate on the HMAC input value. Note that some blockchain protocols first execute the input script of the second transaction Tx₂, followed by the output script of the first transaction Tx₁.

The HMAC script generated by Alice 103a is configured to generate a HMAC of a message based on the HMAC input value. That is, the HMAC generated by the HMAC script will vary depending on the particular value of the HMAC input value. The HMAC script may comprise one or more functions, each function being configured to perform a particular operation.

For instance, the HMAC script may comprise one or more operation codes (opcodes), i.e. instructions, each opcode being mapped to a particular respective operation (the script engine on each node 104 that executes script being configured to perform the respective operation if/when executing an instance of that opcode in a script). In that sense, a script is a list of instructions, in the form of opcodes, recorded within an input or output of a transaction. In general, an opcode can perform one or more of the following operations: (a) output an element to a memory store, (b) retrieve an element from a memory store, or (c) operate on an element in a memory store, and (d) remove an element from a memory store. Operating on an element may include performing a mathematical operation on the element.

As a particular example, the HMAC script may be written in a stack-based scripting language. An example of a stack-based scripting language has been described above with reference to FIG. 5. In such a language, a given opcode mapped to one or more of the following operations: (a) put an element on a stack 503, (b) retrieve an element from the stack 503, (c) operate on an element on the stack 503, and (d) remove an element from the stack. Some stack-based languages may allow for storing data on two stacks, e.g. a main stack and an alternate (stack) stack.

In some examples, the HMAC script may be configured to cause the generated HMAC of the message to be output to a memory store, e.g. a stack 503. That is, at some stage during execution of the HMAC script, the generated HMAC may be output to memory, e.g. the stack 503. The generated HMAC may be output as a final result of executing the HMAC script and/or the output script. Alternatively, the generated HMAC may be output during an intermediate step of the HMAC script and/or the output script.

Recall from above that the general formula (“the HMAC formula”) for a HMAC of a ciphertext, given an HMAC key K_{HMAC} is defined as

HMAC(K_{HMAC},message)=H((K_{HMAC}⊕opad)∥H((K_{HMAC}⊕ipad)∥ciphertext)),

where H is a hash function, or some combination of hash functions. The HMAC script generated by Alice 103a may take one of several forms, depending on the HMAC input that Alice 103a requires of Bob 103b.

In some embodiments, the HMAC script is configured to generate the HMAC of the message based on a HMAC keyK_{HMAC}. That is, the HMAC script is configured to take the HMAC key, K_{HMAC}, as an input from the input script of the second transaction Tx₂, and generate the HMAC. This enables Bob 103b to specify what value is to be used as the HMAC key, K_{HMAC}. In some examples K_{HMAC} is a shared secret between Alice 103a and Bob 103b represented in hexadecimal. In these embodiments, the HMAC input is the HMAC key K_{HMAC}, or at least comprises the HMAC key, K_{HMAC}. Referring to the HMAC formula above, the message is also required to calculate the HMAC. Therefore the HMAC script comprises the message (e.g. a ciphertext) in these embodiments.

As an example, if Alice 103a requires the HMAC input in the unlocking script to be <K_{HMAC}>, the HMAC script may take the following form:

[HMAC script]₍₁₎=OP_DUP<ipad> OP_XOR <message> OP_CAT OP_SHA256 OP_SWAP <opad> OP_XOR OP_SWAP OP_CAT OP_SHA256

In alternative embodiments, the HMAC script is configured to generate the HMAC of the message based on the message (e.g. ciphertext). That is, the HMAC script is configured to take the message, as an input from the input script of the second transaction Tx₂, and generate the HMAC. This enables Bob 103b to specify what value is to be used as the message. In other words, Bob 103b can generate a HMAC of any desired message. In these embodiments, the HMAC input is the message, or at least comprises the message. Referring to the HMAC formula above, the HMAC key, K_{HMAC}, also required to calculate the HMAC. Therefore the HMAC script comprises the HMAC key, K_{HMAC}, in these embodiments.

As an example, if Alice 103a requires the HMAC input in the unlocking script to be <message>, the HMAC script may take the following form:

[HMAC script]₍₂₎=<K_{HMAC}⊕ipad> OP_SWAP OP_CAT OP_SHA256<K_{HMAC}⊕opad> OP_SWAP OP_CAT OP_SHA256.

In alternative embodiments, the HMAC script is configured to generate the HMAC of the message based on the message (ciphertext) in an encrypted form. That is, the HMAC script is configured to take a hash at least the message, as an input from the input script of the second transaction Tx₂, and generate the HMAC. This enables Bob 103b to generate a HMAC of the ciphertext without exposing the message on the blockchain 150. In other words, Bob 103b can generate a HMAC of any desired message, without any third party viewing the message. In these embodiments, the HMAC input is a hash of at least the message, or at least comprises a hash of at least the message. Referring to the HMAC formula above, the HMAC key, K_{HMAC}, is also required to calculate the HMAC. Therefore the HMAC script comprises the HMAC key, K_{HMAC}, in these embodiments.

As an example, if Alice 103a and/or Bob 103b requires the message to be hidden, the HMAC input in the unlocking script may be the result of the internal hash function in the HMAC formula, i.e. <SHA256((K_{HMAC}⊕ipad)∥message)>. The HMAC script may then take the following form:

[HMAC script]₍₃₎=<K_{HMAC}⊕opad> OP_SWAP OP_CAT OP_SHA256.

The opcodes used in the example HMAC scripts above, along with their associated operations, will be familiar to the skilled person. It will be appreciated that certain minor alterations to the example scripts may be made without affecting the outcome of the HMAC script itself, e.g. the inclusion of opcodes which add the number one to the result and then subtract the number one from the result. The inclusion of <ipad> and <opad> are optional and will depend on the length of the input of the hash function. The example HMAC scripts use the SHA-256 hash function. However, any hash function or combination of hash functions may be used instead, e.g. SHA-512.

In some examples, Alice 103a may transmit the message (in plaintext and/or ciphertext) to Bob 103b. For instance, in embodiments where the HMAC script takes the form of [HMAC script]₍₂₎, Alice 103a may transmit the plaintext message or the ciphertext message to Bob 103b in order for Bob 103b to provide it as the HMAC input.

Each of the embodiments described above allow the HMAC of a message to be calculated in script. In some scenarios, Alice 103a may want to verify the HMAC generated as a result of Bob's input with a pre-calculated HMAC. In order to do this, the output script of the first transaction Tx₁ may include a “HMAC verification script”. As for the HMAC script, the HMAC verification script is a label for a portion of script that is included to perform a predetermined function, e.g. as defined by a sequence of opcodes. In these embodiments, the HMAC verification script comprised the pre-calculated, i.e. predetermined, HMAC of the message. The HMAC verification script is then configured to compare the pre-calculated HMAC with the HMAC generated using the HMAC script (from the output script of the first transaction Tx₁) and the HMAC input (from the input script of the second transaction Tx₂), and determine whether or not they correspond to one another, e.g. whether they are identical.

As an example, if Alice 103a would like to compare the result of the pre-calculated HMAC, the HMAC verification script may then take the following form:

[HMAC verification script]=[HMAC in script]₍ᵢ₎<HMAC> OP_EQUALVERIFY

where the (i) index specifies one of the example HMAC scripts given above, and

<HMAC>=<SHA-256((K_{HMAC}⊕opad)∥SHA-256((K_{HMAC}⊕ipad)∥message))>

is the pre-calculated result of the HMAC.

The HMAC verification script may be configured to output a result indicating whether or not the pre-calculated HMAC corresponds to the newly generated HMAC. For instance, an indication may be output to the memory store, e.g. the stack 503. As an example, a representation of “1” or “TRUE” may be output to the stack 503 if the two results match. As another example, the HMAC verification script may be configured to cause the second transaction Tx₂ to be marked as an invalid transaction if the pre-calculated HMAC does not correspond to the newly generated HMAC. This may be achieved by the OP_EQUALVERIFY opcode in the example script above.

In some embodiments, the HMAC generated by the HMAC script may be used to generate a public key. That is, the generated public key is generated as a function of the HMAC. In these embodiments, the output of the first transaction Tx₁ comprises a “public key derivation script”, i.e. a portion of script configured to perform a predefined function, which in this case is to generate a new public key based on the HMAC. The public key derivation script may be configured to cause the new public key to be output to a memory store, e.g. the stack 503.

As an example, the public key derivation script may be configured to perform a point scalar multiplication on the HMAC, whereby the HMAC is multiplied by a generator value. For instance, if the new public key is required to be a public key needed for the elliptic curve digital signature algorithm (ECDSA), the generator value may be an elliptic curve base point, i.e. a point on the elliptic curve. In that case, the generator value is defined by two co-ordinates on the elliptic curve.

For example, the public key derivation may be configured to perform a calculation of:

P_{child}=HMAC(K_{HMAC},message)·G

where P_{child} is the new public key, G is the generator point, and HMAC(K_{HMAC},ciphertext) is the HMAC generated by the HMAC script. An example script for performing a point scalar multiplication ( ) is provided below.

In some embodiments, the new public key may be generated based on a previous public key, i.e. the new public key (e.g. a child public key) may be generated as a function of the HMAC and the previous public key (e.g. a parent public key). The public key derivation script configured to perform a point addition on the HMAC (once converted to a public key, e.g. by multiplying with the generator point), whereby the HMAC is added to the previous public key.

For example, the public key derivation may be configured to perform a calculation of:

P_{child}=Pₚₐᵣₑₙₜ HMAC(K_{HMAC},ciphertext)·G

where Pₚₐᵣₑₙₜ is the previous public key. An example script for performing a point addition (+) is provided below.

In some examples, the message used by the HMAC script to calculate the HMAC, may comprise a public key. The public key may be the previous public key mentioned above, or a different public key. The message may also comprise an index of the previous public key. Additionally or alternatively, the HMAC key, K_{HMAC}, used by the HMAC script to calculate the HMAC may comprise a chain code.

Public keys may be linked to one another in a hierarchical and deterministic way. That is, each public key may exist in a respective level within a hierarchy of levels. A public key in the (n+1)^{th} level of the hierarchy are linked to the public key(s) in the n^{th} level of the hierarchy. The respective level of the public key is denoted by a chain code. A given level may comprise a sequence of one or more public keys. The respective position of a public key in the sequence is denoted by an index.

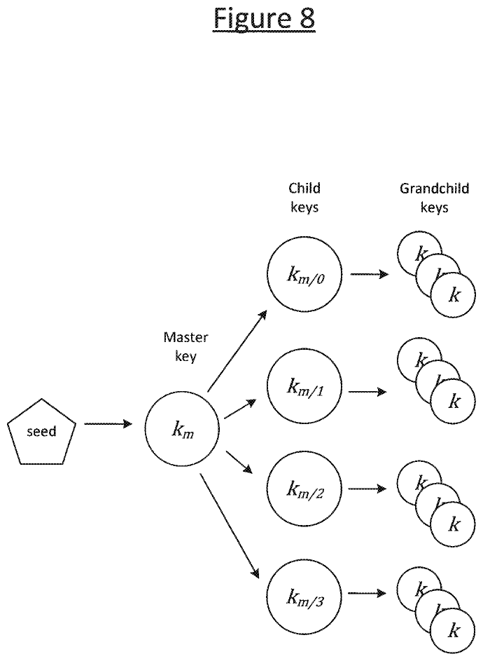

FIG. 8 illustrates an example of a hierarchical deterministic (HD) set of keys, also known as a HD wallet. Here, the master key is generated based on a seed. The child keys in each set of child keys are each generated based on the master key. The grandchild keys in each respective set of grandchild keys are each generated based on a respective set of the child keys. In this example, the master key is the parent key. However, the labels “parent” and “child” may be used to refer to a public key in an n^{th} level and public key an (n+1)^{th} level, wherein the public key in the (n+1)^{th} level is generated based on the public key in the n^{th} level.

In some examples, the public key derivation may be configured to perform a calculation of:

P_{child}=Pₚₐᵣₑₙₜ+HMAC(cₚₐᵣₑₙₜ,Pₚₐᵣₑₙₜ∥index)·G.

where cₚₐᵣₑₙₜ is the chain code of the previous public key, and index is the index of the new public key. In other words, the HMAC script is configured to generate a HMAC of the previous public key, and the public key derivation script is configured to use the result to generate the new public key. In these embodiments, the message (e.g. ciphertext) is equivalent to the previous public key, Pₚₐᵣₑₙₜ. and the index, index, if present.

In some embodiments, the HMAC script is configured to generate the HMAC of the message based on the chain code, cₚₐᵣₑₙₜ. That is, the HMAC script is configured to take the chain code, cₚₐᵣₑₙₜ, as an input from the input script of the second transaction Tx₂, and generate the HMAC. This enables Bob 103b to specify what value is to be used as the chain code, cₚₐᵣₑₙₜ, i.e. the level of the new public key in the hierarchy of levels. In these embodiments, the HMAC input is the chain code, cₚₐᵣₑₙₜ. Referring to the HMAC formula above, the message (now equivalent to Pₚₐᵣₑₙₜ∥index) is also required to calculate the HMAC. Therefore the HMAC script comprises the Pₚₐᵣₑₙₜ)) index in these embodiments, where the index is optional. The public key derivation script is then configured to generate the new public key, P_{child}, based on the generated HMAC and the previous public key, Pₚₐᵣₑₙₜ. The new public key may be output to the memory store, e.g. the stack 503.

In alternative embodiments, the HMAC script is configured to generate the HMAC of the message based on the previous public key, Pₚₐᵣₑₙₜ. That is, the HMAC script is configured to take the previous public key, Pₚₐᵣₑₙₜ, as an input from the input script of the second transaction Tx₂, and generate the HMAC. This enables Bob 103b to specify what public key is to be used as the previous public key (e.g. the master public key). In these embodiments, the HMAC input is the previous public key, Pₚₐᵣₑₙₜ, and, in some examples, the index. Referring to the HMAC formula above, the HMAC key, K_{HMAC}, (now equivalent to the chain code, cₚₐᵣₑₙₜ) is also required to calculate the HMAC. Therefore the HMAC script comprises the chain code, cₚₐᵣₑₙₜ, in these embodiments. The public key derivation script is then configured to generate the new public key, P_{child}, based on the generated HMAC and the previous public key, Pₚₐᵣₑₙₜ. The new public key, P_{child}, may be output to the memory store, e.g. the stack 503.

In alternative embodiments, the HMAC script is configured to generate the HMAC of the message based on the previous public key, Pₚₐᵣₑₙₜ, in an encrypted form. That is, the HMAC script is configured to take a hash of at least the previous public key, as an input from the input script of the second transaction Tx₂, and generate the HMAC. This enables Bob 103b to generate a HMAC of the previous public key, Pₚₐᵣₑₙₜ, without exposing the previous public key, Pₚₐᵣₑₙₜ, on the blockchain 150. In other words, Bob 103b can generate a HMAC of any desired public key, without any third party viewing the previous public key, Pₚₐᵣₑₙₜ. In these embodiments, the HMAC input is a hash of at least the previous public key, Pₚₐᵣₑₙₜ. In some examples, the HMAC input is a hash of the previous public key, Pₚₐᵣₑₙₜ, and the index. Referring to the HMAC formula above, the chain code, cₚₐᵣₑₙₜ, is also required to calculate the HMAC. Therefore the HMAC script comprises the chain code, cₚₐᵣₑₙₜ, in these embodiments. The public key derivation script is then configured to generate the new public key, P_{child}, based on the generated HMAC and the previous public key, Pₚₐᵣₑₙₜ The new public key, P_{child}, may be output to the memory store, e.g. the stack 503.

It is considered best practice to not reuse payment addresses for blockchain transactions, which are derived from public keys. To avoid the need to store multiple randomly generated private keys corresponding to these public keys, hierarchical deterministic (HD) wallets calculate multiple keys from one seed, such that they can easily be stored and regenerated. In one particular blockchain wallet protocol, the equation for calculating a child public key from a parent public key is that given above. i.e.:

P_{child}=Pₚₐᵣₑₙₜ HMAC-SHA512_{L}(cₚₐᵣₑₙₜ,Pₚₐᵣₑₙₜ∥index)·G,

where HMAC-SHA512_{L} is the left 256 bits of the result of the HMAC function using the SHA-512 hash function. In some examples, the HMAC script is configured to output a predetermined number of bits of the result of the HMAC, e.g. the left 256 bits. Explicitly, the equation for this HMAC function is

HMAC-SHA512(cₚₐᵣₑₙₜ,Pₚₐᵣₑₙₜ∥index)=SHA512((cₚₐᵣₑₙₜ⊕opad)∥SHA512(cₚₐᵣₑₙₜ⊕ipad)∥Pₚₐᵣₑₙₜ∥index))

and only the left 256 bits of this result are used in the child public key calculation. The right 256 bits will correspond to the chain code of the child key c_{child}, which will be used in the derivation of grandchild keys.

The parent chain code is used in the derivation of child keys, where cₚₐᵣₑₙₜ is the chain code corresponding to the parent public key Pₚₐᵣₑₙₜ Explicitly, this is

cₚₐᵣₑₙₜ=HMAC-SHA512_{R}(c_{grandparent},P_{grandparent}∥indexₚₐᵣₑₙₜ),

where the subscript R represents the fact that it is the right 256 bits of the result of the HMAC calculation. Chain codes are used in child key derivations simply to introduce entropy into the calculation.

Then 0≤index<2³¹ is the index corresponding to the child key. Note that this indexing starts at 0. The index is introduced so that multiple child keys can be derived from a single parent. Each of this child keys can then be used as parent keys and derive multiple grandchild keys, for each child key.

Finally, note that G given in the equation for P_{child} is a point on an elliptic curve, which may be specified by the secp256k1 elliptic curve. Since HMAC-SHA512_{L}(c, Pₚₐᵣₑₙₜ∥index) results in an integer, the second term in the P_{child} calculation is notation for this point G to be added to itself the number of times specified by this HMAC result.

A benefit of deriving keys explicitly on chain is that a user can prove the link between two public keys that they own, and therefore there is an immutable record of that proof. This would be especially useful in the context of public key infrastructure (PKI), where a single public key can be certified. Then, by virtue of this proof of a link being on chain, related public keys could be certified by extension.

Another benefit of calculating a child key in script is that this child key could be used to sign transactions but never explicitly be stored on chain. As a result, if an adversary is searching for transactions containing a given child public key, they would not find the transactions that use this method. This increases privacy to users of this method.

### Public Key Derivation in Script

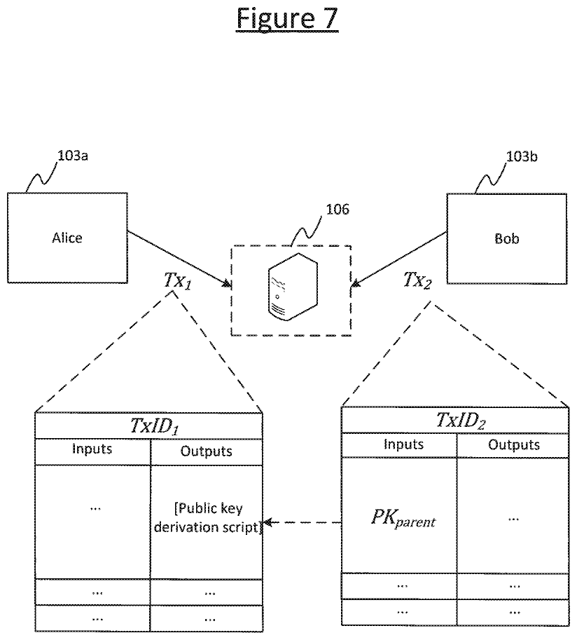

FIG. 7 schematically illustrates a system for generating a public key using transactions of a blockchain 150. The system comprises the respective computer equipment 102a, 102b (not shown) of a first party (Alice) 103a and a second party (Bob) 103b. Note that actions described as being performed by Alice 103a or Bob 103b are taken to mean actions performed by the respective computer equipment of Alice or Bob. Alice 103a generates an output script of a first blockchain transaction Tx₁. The output script comprises a public key derivation (PKD) script. The PKD script is a portion of the output script configured to perform a particular function (which will be described below). The output script is included within an output of the first transaction. The first transaction Tx₁ may comprise one or more additional outputs, each having a respective output script. In some examples, one, some or all of the additional outputs each comprise an output script that includes a respective PKD script. As is required by the blockchain protocol, the first transaction Tx₁ includes one or more inputs. In the example of FIG. 7, Alice 103a generates the first transaction Tx₁ and transmits the first transaction Tx₁ to the blockchain network 106. If the first transaction Tx₁ is deemed to be a valid transaction it will be recorded in a block 151 of the blockchain 150. In other examples, Alice 103a may transmit the first transaction Tx₁ to Bob 103b or to a third party (not shown) responsible for transmitting the first transaction Tx₁ to the blockchain network 106, e.g. after adding, to the first transaction Tx₁, one or more additional inputs and/or one or more additional outputs.

Once the first transaction Tx₁ has been transmitted to the blockchain network 106, Bob may generate a second transaction Tx₂ comprising an input. The input of the second transaction Tx₂ references the output of the first transaction Tx₁, i.e. the output comprising the PKD script, and comprises an input script comprising a first public key PK₁ (also referred to below as a “parent public key”). The broken-line arrow in FIG. 7 illustrates the input of the second transaction Tx₂ referencing the output of the first transaction Tx₁. If the first transaction Tx₁ comprises several outputs that each include a respective HMAC script, the input of the second transaction Tx₂ references one of those outputs. When the output script of the first transaction Tx₁ is executed alongside the input script of the second transaction Tx₂, the PKD script is configured to operate on the first public key PK₁. Note that some blockchain protocols first execute the input script of the second transaction Tx₂, followed by the output script of the first transaction Tx₁.

Note that in some examples the same party may in fact generate both the first transaction Tx₁ and the second transaction Tx₂. In other words, some or all of the actions described as being performed by Bob 103b in the preceding paragraphs may be performed by Alice 103a.

The PKD script generated by Alice 103a is configured to use the first public key PK₁ to generate a second public key PK₂ (also referred to below as a “child public key”). That is, the second public key PK₂ is based on the first public key PK₁. The PKD script may comprise one or more functions, each function being configured to perform a particular operation.

For instance, the PKD script may comprise one or more operation codes (opcodes), i.e. instructions, each opcode being mapped to a particular operation. In that sense, a script is a list of instructions, in the form of opcodes, recorded within an input or output of a transaction. In general, an opcode can perform one or more of the following operations: (a) output an element to a memory store, (b) retrieve an element from a memory store, or (c) operate on an element in a memory store, and (d) remove an element from a memory store. Operating on an element may include performing a mathematical operation on the element.

As a particular example, the PKD script may be written in a stack-based scripting language. An example of a stack-based scripting language has been described above with reference to FIG. 5. In such a language, a given opcode is configured to perform one or more of the following operations: (a) put an element on a stack 503, (b) retrieve an element from the stack 503, (c) operate on an element on the stack 503, and (d) remove an element from the stack. Some stack-based languages may allow for storing data on two stacks, e.g. a main stack and an alternate (stack) stack.

In some examples, the PKD script may be configured to cause the generated second public key PK₂ to be output to a memory store, e.g. a stack 503. That is, at some stage during execution of the PKD script, the second public key PK₂ may be output to memory, e.g. the stack 503. The second public key PK₂ may be output as a final result of executing the PKD script and/or the output script. Alternatively, the second public key PK₂ may be output during an intermediate step of the PKD script and/or the output script.

In general, the PKD script is configured to calculate the following:

PK₂=f(PK₁)

where f( ) is a function, defined by the PKD script, that operates on the first public key PK₁. The second public key PK₂ is said to be linked to the first public key PK₁ in that it is based on the first public key PK₁, e.g. there is a mathematical link between the first and second public keys.

In some embodiments, the PKD script may comprise a “hashing script”. The hashing script is a label for a portion of script that is configured to perform a predetermined function, e.g. as defined by a sequence of opcodes. The hashing script is configured to apply a hash function (e.g. SHA-256, SHA512) to at least the first public key PK₁ to generate a hash result. In some examples, applying the hash function may comprise applying the same hash function multiple times (e.g. applying the SHA-512 function twice), or applying one or more different hash functions (e.g. applying the SHA-512 function, followed by the SHA-256 function), or a combination of both (e.g. applying the SHA-256 function twice, followed by the SHA-512 function). In some examples, the hashing script may be configured to apply the hash function to only the first public key. In other examples, the hash function may apply the hash function to the first public key PK₁ and one or more further data items. The data item(s) may be included in the hashing script, or included in the input script of the second transaction. In some examples, one or more of the data items may be included in the hashing script and one or more different ones of the data items may be included in the input script of the second transaction. The hashing script may be configured to cause the hash result to be output to the memory store, e.g. the stack 503.

In general, when the PKD script comprises the hashing script, the PKD script is configured to calculate the following:

PK₂=f(PK₁)

where f( ) comprises a hash function h, e.g. PK₂=PK₁+h(PK₁).

In some examples, the hashing script may be a hash-based message authentication code, HMAC, script, wherein the hash function is a HMAC function. The hashing script is a label for a portion of script that is configured to perform a predetermined function, e.g. as defined by a sequence of opcodes. The HMAC script is configured to apply the HMAC function to generate a HMAC of at least the first public key. Typically, as is known in the art, a HMAC is taken of a “message”. In some examples, according to embodiments of the present invention, the message may consist of the first public key PK₁. Alternatively, the message may comprise the first public key PK₁ and the one or more further data items discussed above with reference to the “hashing function”.

In general, when the PKD script comprises the HMAC script, the PKD script is configured to calculate the following:

PK₂=f(PK₁)

where f( ) comprises a HMAC function h, e.g. PK₂=PK₁+HMAC(PK₁).

Examples of alternative HMAC scripts are provided below. The HMAC script of the PKD script may take the form of any of those HMAC scripts. As another example, the HMAC script may be configured to operate on the first public key to generate the following HMAC:

HMAC-SHA512(cₚₐᵣₑₙₜ,Pₚₐᵣₑₙₜ∥index)=SHA512((cₚₐᵣₑₙₜ⊕opad)∥SHA512(cₚₐᵣₑₙₜ⊕ipad)∥Pₚₐᵣₑₙₜ∥index)),

where Pₚₐᵣₑₙₜ denotes the first public key, cₚₐᵣₑₙₜ defines a chain code of the first public key PK₁, and index defines an index of the second public key. Chain codes and indexes are described below. That is, in these examples, the HMAC script is configured to apply the HMAC function to a message comprising the chain code, the first public key PK₁, and the index. In some examples, the message may comprise the first public key PK₁ and the chain code, but not the index. In other examples, the message may comprise the first public key PK₁ and the index, but not the chain code. In some examples, the chain code and/or the index may be included in the HMAC script itself. In other examples, the chain code and/or the index may be included in the input script of the second transaction. Note that the SHA-512 function may be replaced with any other suitable hash function.

As an illustrative example, a HMAC script that takes a parent public key <Pₚₐᵣₑₙₜ> as an input, and calculates HMAC-SHA512(cₚₐᵣₑₙₜ, Pₚₐᵣₑₙₜ∥index) may be defined to be

[HMAC-SHA512]=<index> OP_CAT<cₚₐᵣₑₙₜ⊕ipad> OP_SWAP OP_CAT OP_SHA512<cₚₐᵣₑₙₜ⊕opad> OP_SWAP OP_CAT OP_SHA512

where OP_SHA512 is an opcode configured to pop the top item of the stack and return the SHA-512 hash of it to the stack.

In some examples, the HMAC of the message generated by the HMAC function may be larger than required, i.e. the number of bytes of the HMAC of the message may exceed a required number. The HMAC script may be configured to generate the hash result as a predetermined number of bytes of the HMAC of the message, e.g. a leading number of bytes of the HMAC may be retained as the hash result. For example, if only 32 bytes (256 bits) are required, the HMAC script may be configured to output the leading 32 bytes of the HMAC to the memory store, e.g. the stack 503.

As an example, the HMAC script may comprise the following opcodes:

[HMAC-SHA512]<0x20> OP_SPLIT OP_DROP

wherein the opcodes following the previously defined HMAC script are configured to drop the right 32 bytes of the result of the function [HMAC-SHA512]. Note that <0x20> is equivalent to 32 in decimal representation. <0x20> may be replaced with any number representing the desired number of bytes to be returned by the HMAC function.

In some embodiments, the PKD script may comprise a “point scalar multiplication (PSM) script”. The PSM script is a label for a portion of script that is configured to perform a predetermined function, e.g. as defined by a sequence of opcodes. The PSM script is configured to generate a second data value as a result of performing a point scalar multiplication of a first data value with a predetermined generator point of an elliptic curve. In other words, the PSM script is configured to perform an elliptic curve point multiplication.

For example, the PSM script may be required to convert the hash result into the form of a public key, e.g. to be added to the first public key. Elliptic curve point multiplication is the operation of successively adding a point along an elliptic curve to itself repeatedly. Here, the generator point is a point on the elliptic curve, e.g. the secp256k1 elliptic curve. Elliptic curve point multiplication is defined as rP=P+P+P+P+ . . . +P for some scalar (integer) r and a point P=(x,y) that lies on the curve, E (e.g. E: y²=x³+ax+b). In this case, r is the first data value and P is the generator point.

The PKD script may be configured to generate the second public key based on the first public key PK₁ and the second data value (which is generated based on the generator point). In some examples, the first data value may be included in the input script of the second transaction. In other examples, the first data value may comprise the hash result generated by the hashing script.

In general, when the PKD script comprises the PSM script, the PKD script is configured to calculate the second value q·G, where q is the first data value, G is the generator point and represent a point multiplication.

As an example, the PKD script may be configured to calculate the following:

PK₂=PK₁+h(PK₁)·G,

e.g. PK₂=PK₁+HMAC(PK₁)·G

The PSM script may be configured to cause the second data value to be output to the memory store, e.g. the stack.

In examples, the first data value (e.g. the hash result) may be represented in binary. In these examples, the PSM script is configured to generate the second data as a point on the elliptic curve, i.e. two co-ordinates indicating a point on the elliptic curve. The co-ordinates may be represented in hexadecimal or otherwise.

In some embodiments, the PKD script may comprise a “binary conversion script”. The binary conversion script is a label for a portion of script that is configured to perform a predetermined function, e.g. as defined by a sequence of opcodes. The binary conversion script is configured to convert a decimal or hexadecimal representation of a data item to a binary representation of the data item. For instance, the binary conversion script may be configured to convert a decimal or hexadecimal representation of the first data value (e.g. the hash result) to a binary representation of the first data value.

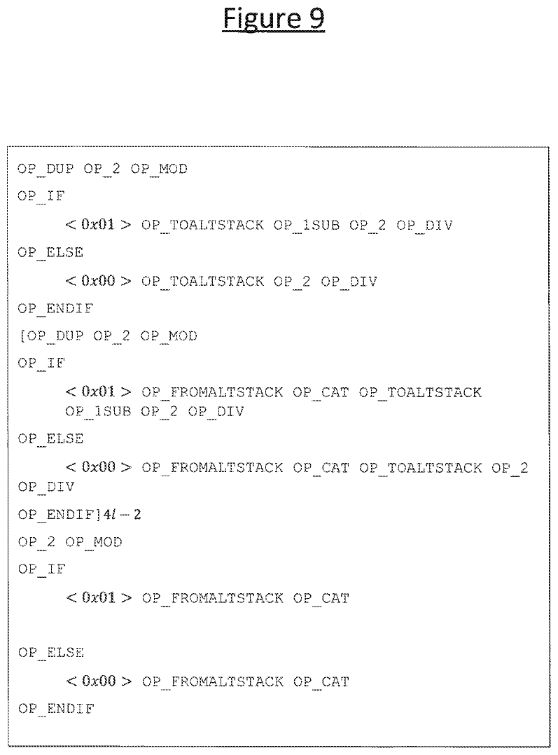

An example binary conversion script [Hex to binary] using opcodes is provided in FIG. 9. The square brackets to the power 4l−2 around the opcodes indicate that these should be repeated 4l−2 times, where n is the number of bytes that is being transformed into binary. For example, the number of bytes may be l=32. The −2 is to take account of the first and last rounds, which are slightly different. Note that whilst this function is labelled [Hex to binary], “Hex” being short for hexadecimal, the same function may also be used to covert a decimal representation to a binary representation.

In some embodiments, the PKD script may comprise a “point addition script”. The point addition script is a label for a portion of script that is configured to perform a predetermined function, e.g. as defined by a sequence of opcodes. The point addition script is configured to perform a point addition of the first public key PK₁ and a third public key PK₃. In some examples, the result of the point addition of the first and third public keys is the second public key, i.e. the public key generated by the PKD script. The addition of two points on an elliptic curve (or the addition of one point to itself) yields a third point on the elliptic curve whose location has no immediately obvious relationship to the locations of the first two points. A particular example of a point scalar multiplication script is provided below.

In general, when the PKD script comprises the point addition script, the PKD script is configured to calculate the following:

PK₂=f(PK₁,PK₃)

where f( ) comprises point addition function, e.g. PK₂=PK₁+PK₃, where + is a point addition operation.

The third public key PK₃ may be included in the input script of the second transaction. Alternatively, the third public key may be generated as a result of the execution of the PKD script. As an example, the third public key PK₃ may be the second value, i.e. the value generated by the PSM script, i.e. PK₃=q·G. In that case, the second public key PK₂ may be PK₂=PK₁+q·G. As another example, the third public key PK₃ may be based on the hash result, e.g. PK₃=h(PK₁)·G. In that case, the second public key PK₂ may be PK₂=PK₁+h(PK₁)·G, or PK₂=PK₁+HMAC(PK₁)·G.

Performing a point addition may comprise adding two distinct points, or adding the same point to itself, i.e. point doubling. With 2 distinct points, P and Q, addition is defined as the negation of the point resulting from the intersection of the curve, E, and the straight line defined by the points P and Q, giving the point, R. Where the points P and Q, are coincident (at the same coordinates), addition is similar, except that there is no well-defined straight line through P, so the operation is closed using limiting case, the tangent to the curve, E, at P.

In more detail, assuming an elliptic curve group E∩ [symbol] , where E is the set of points (x, y) which satisfy

y²=(x³+ax+b)mod p,

with a, b, and p being parameters set by a given scheme, satisfying 4a³+27b²≠0, and [symbol] being defined as the point at infinity and the identity element of the group, then point addition + is then defined by the following definitions:
1. If P=(x₁, y₁) and Q=(x₂, y₂) with x₁≠x₂, then P+Q=(x₃, y₃), where

x₃=(y₂−y₁)²(x₂−x₁)⁻²−x₁−x₂ mod p,

y₃=(y₂−y₁)(x₂−x₁)⁻¹(x₁−x₃)−y₁ mod p,
with the operations being usual arithmetic modulo p.
2. If P=(x₁, y₁) and Q=(x₁, y₁) with y₁≠0, then P+P=(x₂, y₂) where

x₂=(3x₁²+a)²(2y₁)⁻²−2x₁ mod p,

y₂=(3x₁²+a)(2y₁)⁻¹(x₁−x₂)−y₁ mod p,
with the operations again being usual arithmetic modulo p.
3. If P=(x₁, y₁) and Q=(x₁, −y₁), the P+Q= [symbol] .
4. For any PϵE∩ [symbol] , P+ [symbol] = [symbol] +P=P.
   Note that in the case of point doubling when y₁=0, the third definition where P=Q is used.

The point addition script may be configured to first determine the relationship between the first and third public keys (e.g. whether they are the same public key), and apply one of several predefined functions in response to the determination. That is, if the first and third public keys are the same public keys, the point addition script may be configured to generate the second public key PK₂ by applying the second definition of point addition. If the first and third public keys are different public keys, the point addition script may be configured to generate the second public key PK₂ by applying the first definition of point addition (depending on how the first and third public keys differ). Example point addition scripts for performing a point addition are provided below.

The point addition script may be configured to generate the second public key PK₂ by generating a first co-ordinate (e.g. x co-ordinate) of the second public key PK₂ and a second co-ordinate (e.g. y co-ordinate) of the second public key. The point addition script may be further configured to output the first and second co-ordinates of the second public key PK₂ to the memory store, e.g. the stack 503. In some examples, the point addition script may be configured to combine (e.g. concatenate) the first and second co-ordinates and output the result to the memory store, e.g. the stack 503.

The following examples describe how the public key derivation script can be used to derive a HD wallet child key from a parent key, the parent key being included in an input script of a second transaction. It will be appreciated that some or all of the individual example scripts may be used in isolation or in combination with fewer than all of the individual scripts, depending on the desired result. In addition, the following examples describe the derivation of a child key according to the BIP32 protocol, which uses a HMAC function as a particular form of a hash function. It will be appreciated that other hash functions may be used.

The PKD script may be configured to implement the following equation for deriving a child public key P_{child} (the second public key) from a parent public key Pₚₐᵣₑₙₜ (the first public key):

P_{child}=Pₚₐᵣₑₙₜ+HMAC-SHA512_{L}(cₚₐᵣₑₙₜ,Pₚₐᵣₑₙₜ∥index)·G,

where HMAC-SHA512_{L} is the left 32 bytes of the result of the HMAC-SHA512 function, cₚₐᵣₑₙₜ is the chain code corresponding to the parent key, and index is the index corresponding to the child key.

This calculation can then be done in script in the following way. The unlocking script is <Pₚₐᵣₑₙₜ> which is the uncompressed format of the parent public key, without the prefix 04 that specifies this format. It is therefore the x and y coordinate concatenated. In order to derive the child key from this, the following locking script may be used:

[P_{child} derivation]=OP_DUP<0x20> OP_SPLIT OP_SWAP OP_ROT

[HMAC-SHA512]<0x20> OP_LEFT

[Hex to binary] [Point scalar multiplication] [Point addition],

where each set of square brackets is a set of opcodes that execute the description given. Each function of [P_{child} derivation] is now described in detail. The functions contained in the calculation have all been written such that they can be used independently of each other.

The first opcodes OP_DUP <0x20> OP_SPLIT OP_SWAP OP_ROT duplicate the input parent key Pₚₐᵣₑₙₜ, as the parent key is required twice in the calculation of the child key P_{child}. It then splits the copy into its x and y coordinate, which correspond to the left and right 32 bytes respectively, and places these at the bottom of the stack, as this is the required format for the final function [Point addition]. After these opcodes are executed, the state of the stack is the following:

< Pₚₐᵣₑₙₜ >
< Pₚₐᵣₑₙₜ(x) >
< Pₚₐᵣₑₙₜ(y) >

The HMAC-SHA512 function (i.e. the HMAC script) is now calculated in Script. The function [HMAC-SHA512] takes a parent public key <Pₚₐᵣₑₙₜ> as input, and calculates HMAC-SHA512 (cₚₐᵣₑₙₜ, Pₚₐᵣₑₙₜ∥index). This function is defined to be

[HMAC-SHA512]=<index> OP_CAT<cₚₐᵣₑₙₜ ipad> OP_SWAP OP_CAT OP_SHA512<cₚₐᵣₑₙₜ opad> OP_SWAP OP_CAT OP_SHA512,

where OP_SHA512 is an opcode configured to pop the top item of the stack and return the SHA-512 hash of it to the stack. After execution of this HMAC function, the state of the stack is the following:

```
< HMAC-SHA512(cₚₐᵣₑₙₜ,Pₚₐᵣₑₙₜ
    ∥ index) >
  < Pₚₐᵣₑₙₜ(x) >
  < Pₚₐᵣₑₙₜ(y) >
```

Then the next opcodes <0x20> OP_SPLIT OP_DROP drop the right 32 bytes of the result of the function [HMAC-SHA512]. The state of the stack after this point is now the following:

```
< HMAC-SHA512_{L}(cₚₐᵣₑₙₜ,Pₚₐᵣₑₙₜ
    ∥ index) >
  < Pₚₐᵣₑₙₜ(x) >
  < Pₚₐᵣₑₙₜ(y) >
```

The resulting number HMAC-SHA512_{L}(cₚₐᵣₑₙₜ, Pₚₐᵣₑₙₜ∥index) is then changed from hexadecimal to binary. Next, in order to calculate the [Point scalar multiplication], the input to the function is required to be in binary, so a function (i.e. the binary conversion script) is defined to convert the hexadecimal result of the HMAC into bytes each representing a binary digit. As mentioned above, the [Hex to binary] is shown in FIG. 9.

The following is an illustrative example of the [Hex to binary] function when executed. In this example, the hexadecimal <0x07> is converted into its binary representation 0111. In this case, n=1. The columns in white represent the stack and the columns in grey represent the altstack. The flow of the stack is from left to right and then top to bottom.

| | | | | | | |
|---|---|---|---|---|---|---|
| < 0x07 > | OP_DUP | < 0x01 > | OP_IF | < 0x03 > | < 0x01 > | OP_DUP |
| | OP_2 | < 0x07 > | < 0x01 > | | | OP_2 |
| | OP_MOD | | OP_TOALTSTACK | | | OP_MOD |
| | | | OP_1SUB | | | |
| | | | OP_2 OP_DIV | | | |

| | | | | |
|---|---|---|---|---|
| < 0x01 > | < 0x01 > | OP_IF < 0x01 > | < 0x01 > | OP_CAT |
| < 0x03 > | | OP_FROMALTSTACK | < 0x01 > | OP_TOALTSTACK |
| | | | < 0x03 > | OP_1SUB OP_2 |
| | | | | OP_DIV |

| | | | | |
|---|---|---|---|---|
| < 0x01 > | < 0x0101 > | OP_DUP OP_2 | < 0x0101 > | OP_CAT |
| | | OP_MOD OP_IF < 0x01 > | < 0x01 > | OP_TOALTSTACK |
| | | OP_FROMALTSTACK | < 0x01 > | OP_1SUB OP_2 |
| | | | | OP_DIV |

| | | | |
|---|---|---|---|
| < 0x00 > | < 0x010101 > | OP_2 OP_MOD OP_ELSE | < 0x00010101 > |
| | | < 0x00 > OP_FROMALTSTACK | |
| | | OP_CAT | |

The function converts the hexadecimal <0x07> to its binary representation <0x00010101> where each byte represents one bit. Note that the 0x prefix denotes that the bytes following it are a hexadecimal number, and so <0x00010101> isn't actually equivalent to 0x07 in binary, but the way that the next opcodes read this representation will treat it as such. If it is read exactly as it is written, <0x00010101> is equivalent to the decimal 65793. The state of the stack after execution of the function [Hex to binary] is the following:

```
< Binary representation of HMAC-SHA512_{L}(cₚₐᵣₑₙₜ,Pₚₐᵣₑₙₜ
  ∥ index) >
    < Pₚₐᵣₑₙₜ(x) >
    < Pₚₐᵣₑₙₜ(y) >
```

The function [Hex to binary] results in a string where each byte now represents one bit. For this particular example PKD script, the string must be split into an array using the following opcodes:

[OP_1 OP_SPLIT OP_SWAP]²⁵⁶

where the square brackets to a power indicate the number of times this should be repeated, which in this case is 256 times. This results in a binary array of length 256 where the byte representing the least significant bit is at the top of the stack. Each byte in the array represents one bit and is either <0x01> or <0x00>. The above described process involves concatenating the binary representation in the conversion to binary and then splitting the result into an array. The reason for this split is that the result is required to be in little endian format. This result may be achieved without concatenation, but it would require keeping track of the depth of the stack and then to keep bringing stack items to the top, whilst keeping the order. It is much simpler to concatenate the result into one string, utilise the altstack, and split it afterwards, as achieved by the scripts above.

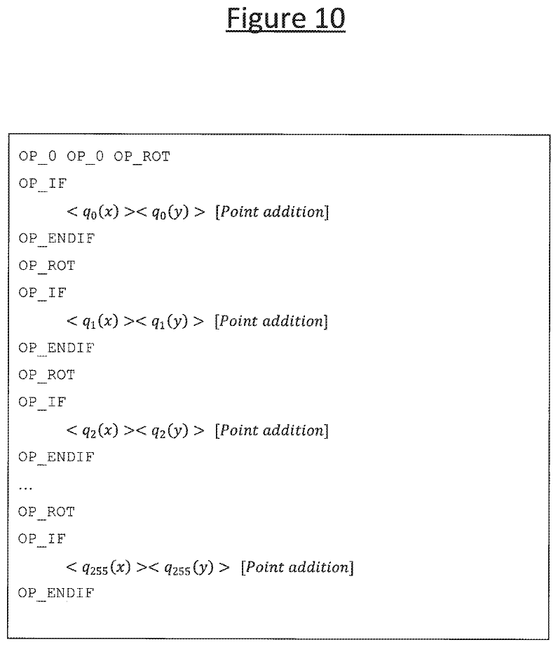

The following illustrates an example of how to perform the point scalar multiplication in Script. The [Point scalar multiplication] function (i.e. the PSM script). The [Point scalar multiplication] function takes the HMAC function result (in some examples, only the left 32 bytes of the HMAC function result) as a binary representation and returns HMAC-SHA512_{L}(c, Pₚₐᵣₑₙₜ∥i)·G. For simplicity of notation, the following definition is used: q:=HMAC-SHA512_{L}. Then the corresponding point q·G:=HMAC-SHA512_{L} G can be calculated. To calculate q·G in script, first pre-calculate q₀=2⁰·G, q₁=2¹·G, . . . , q₂₅₅=2²⁵⁵·G. This allows for the calculation of any possible q·G for 0≤q<2²⁵⁶. This is because, taking a binary representation as input, if the ith digit of the binary representation is 1, the corresponding 2ⁱ will be added to the current state of the calculation of q·G. If the ith digit is 0, the corresponding 2ⁱ will not be added to the current state of the calculation of q·G. An example PSM script for achieving this is illustrated in FIG. 10. Assuming an input q in the form of a little-endian binary array, the examples script in FIG. 10 calculates q·G, where <qᵢ(x)> represents the x-coordinate of 2ⁱ·G and <qᵢ(y)> represents the y-coordinate of 2ⁱ·G.

This function adds the point 2ⁱ·G to the current state of q·G when the corresponding bit of q is equal to 1. This function uses [Point addition] (i.e. the point addition script), which is described below. The [Point scalar multiplication] function begins by pushing <0x00> <0x00> to the stack, the purpose of which is to act as an initial point, which in this case is the identity element. Since the [Point addition] takes two points as input, without pushing <0x00> <0x00> to the stack initially, the first execution of this will only have one input and will result in an error. In essence, <0x00> <0x00> acts as the identity element, since [Point addition] is defined in a way that if one point is <0x00> <0x00>, then the function simply outputs the other point. Note that the reason it is safe to choose this notation as the identity is because the point (0,0) is not a point on the secp256k1 elliptic curve. The state of the stack at this point is now the following:

```
< (HMAC-SHA512_{L}(cₚₐᵣₑₙₜ,Pₚₐᵣₑₙₜ ∥ index) · G) (x) >
< (HMAC-SHA512_{L}(cₚₐᵣₑₙₜ,Pₚₐᵣₑₙₜ ∥ index) · G) (y) >
  < Pₚₐᵣₑₙₜ(x) >
  < Pₚₐᵣₑₙₜ(y) >
```

where the top two items are the x- and y-coordinates of the result of the calculation of HMAC-SHA512_{L}(cₚₐᵣₑₙₜ, Pₚₐᵣₑₙₜ∥index)·G.

The [Point addition] function is the final function used in the child key derivation. It takes the result of [Point scalar multiplication] and the Pₚₐᵣₑₙₜ key, which has been stored at the bottom of the stack since it was duplicated in the first few opcodes of the function [P_{child} derivation], and returns P_{child} to the stack. There are a few functions that need to be calculated before defining the full function. These are:
[Inverse mod p]
[Different Point addition]
[Same Point addition]

First, an example of an inverse modulo p in Script is described, which will be used in the addition of two points. Fermat's little theorem states that

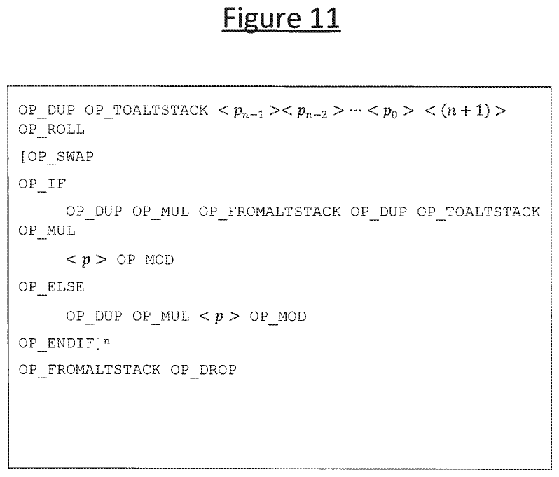

m⁻¹=m^{p-2} mod p. Assuming that the input p is known, then the code shown in FIG. 11 can be used to find the inverse of m modulo p, that is, to calculate m^{p-2} mod p. <pₙ₋₁> <pₙ₋₂> . . . <p₀> represents an array, where each item of the array corresponds to the binary index of (p−2), that is, p′=p−2=p₀2⁰+p₁2¹+ . . . +pₙ₋₁2ⁿ⁻¹, where the opcodes in FIG. 11 calculate the function [Inverse mod p] given the input <m>.

In this example, n is 256, which is the binary length of p. The opcode <(n+1)> combined with OP_ROLL brings <m> to the top of the stack after the binary array of p−2 is pushed onto the stack. p−2 is pushed to the stack at this point to ensure this inverse function is self-contained and so can easily be applied in other cases. Again, the notation of the square brackets to the power indicate the number of times this code is repeated.

FIG. 12 illustrates an example script for performing a point addition. In this case, the example script performs a point addition of two different points. When adding two different points, the input is <y₂> <x₂> <y₁> <x₁>, where each coordinate is a 32-byte hexadecimal. Then the code in FIG. 12 calculates the function [Different Point addition], returning <y₃> <x₃> to the stack. The following illustrates the state of the stack at the end of every line in the code of FIG. 12. The state of the stack begins with the input, and then each row of the example code is executed in turn.

| | | | | | |
|---|---|---|---|---|---|
| < x₁ > | OP_3 OP_PICK | < (x₂ − x₁)⁻¹ > | OP_5 | < y₂ − y₁ > | OP_MUL |
| < y₁ > | OP_OVER | < x₁ > | OP_PICK | < (x₂ − x₁)⁻¹ > | OP_DUP |
| < x₂ > | OP_SUB | < y₁ > | OP_4 | < x₁ > | OP_DUP |
| < y₂ > | [Inverse mod p] | < x₂ > | OP_PICK | < y₁ > | OP_MUL |
| | | < y₂ > | OP_SUB | < x₂ > | |
| | | | | < y₂ > | |

| | | | |
|---|---|---|---|
| < (y2 − y1)² · (x₂ − x₁)⁻² > | OP_3 | < x₃ > | OP_DUP |
| < (y₂ − y₁)(x₂ − x₁)⁻¹ > | OP_PICK | < (y₂ − y₁)(x₂ − x₁)⁻¹ > | OP_4 |
| < x₁ > | OP_6 | < x₁ > | OP_PICK |
| < y₁ > | OP_PICK | < y₁ > | OP_SUB |
| < x₂ > | OP_ADD | < x₂ > | OP_3 |
| < y₂ > | OP_SUB | < y₂ > | OP_ROLL |
| | < p > | | OP_MUL |
| | OP_MOD | | |

| | | | | |
|---|---|---|---|---|
| < (y₂ − y₁)(x₂ − x₁)⁻¹(x₁ − x₃) > | OP_4 | < x₃ > | [OP_3 | < x₃ > |
| < x₃ > | OP_PICK | < y₃ > | OP_ROLL | < y₃ > |
| < x₁ > | OP_SUB | < x₁ > | OP_DROP]⁴ | |
| < y₁ > | < p > | < y₁ > | | |
| < x₂ > | OP_MOD | < x₂ > | | |
| < y₂ > | OP_SWAP | < y₂ > | | |

This completes the calculation of adding different points in Script.

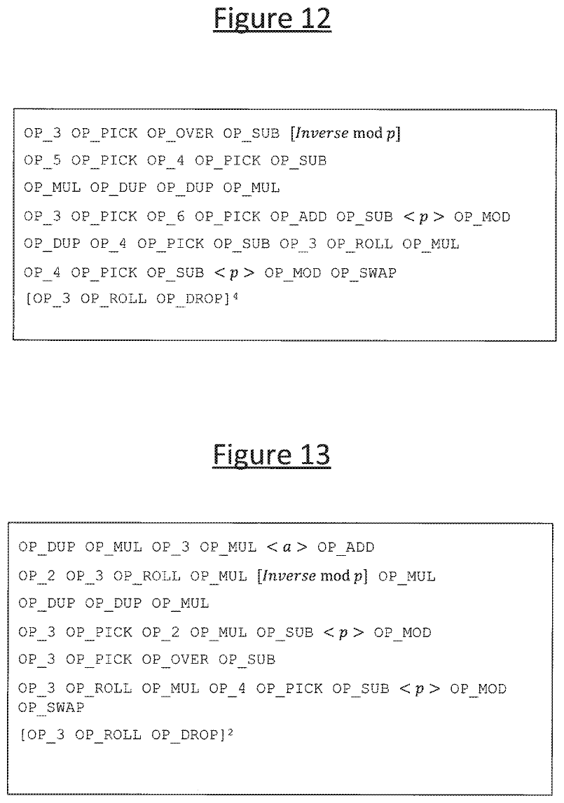

FIG. 13 illustrates another example script for performing a point addition. In this case, the example script performs a point addition of the same point. When adding two same points, the input is <y₁> <x₁> <y₁> <x₁>, where each coordinate is a 32-byte hexadecimal. Then the code in FIG. 13 calculates the function [Same Point addition], returning <y₂> <x₂> to the stack. The following illustrates the state of the stack at the end of every line in the code of FIG. 13. The state of the stack begins with the input, and then each row of the example code is executed in turn. Note that a is a constant that is defined by the elliptic curve, which in this example is secp256k1, and so a=7.

| | | | | | |
|---|---|---|---|---|---|
| < x₁ > | OP_DUP | < 3x₁² + a > | OP_2 OP_3 | < (3x₁² + a) · (2y₁)⁻¹ > | OP_DUP |
| < y₁ > | OP_MUL | < y₁ > | OP_ROLL | < x₁ > | OP_DUP |
| < x₁ > | OP_3 | < x₁ > | OP_MUL | < y₁ > | OP_MUL |
| < y₁ > | OP_MUL | < y₁ > | [Inverse mod p] | | |
| | < a > | | OP_MUL | | |
| | OP_ADD | | | | |

| | | | |
|---|---|---|---|
| < (3x₁² + a)²(2y₁)⁻² > | OP_3 OP_PICK OP_2 | < x₂ > | OP_3 |
| < (3x₁² + a)(2y₁)⁻¹ > | OP_MUL OP_SUB < p > | < (3x₁² + a)(2y₁)⁻¹ > | OP_PICK |
| < x₁ > | OP_MOD | < x₁ > | OP_OVER |
| < y₁ > | | < y₁ > | OP_SUB |

| | | | | |
|---|---|---|---|---|
| < x₁ − x₂ > | OP_3 OP_ROLL | < x₂ > | [OP_3 OP_ROLL | < x₂ > |
| < x₂ > | OP_MUL OP_4 | < y₂ > | OP_DROP]² | < y₂ > |
| < (3x₁² + a)(2y₁)⁻¹ > | OP_PICK | < x₁ > | | |
| < x₁ > | OP_SUB < p > | < y₁ > | | |
| < y₁ > | OP_MOD | | | |
| | OP_SWAP | | | |

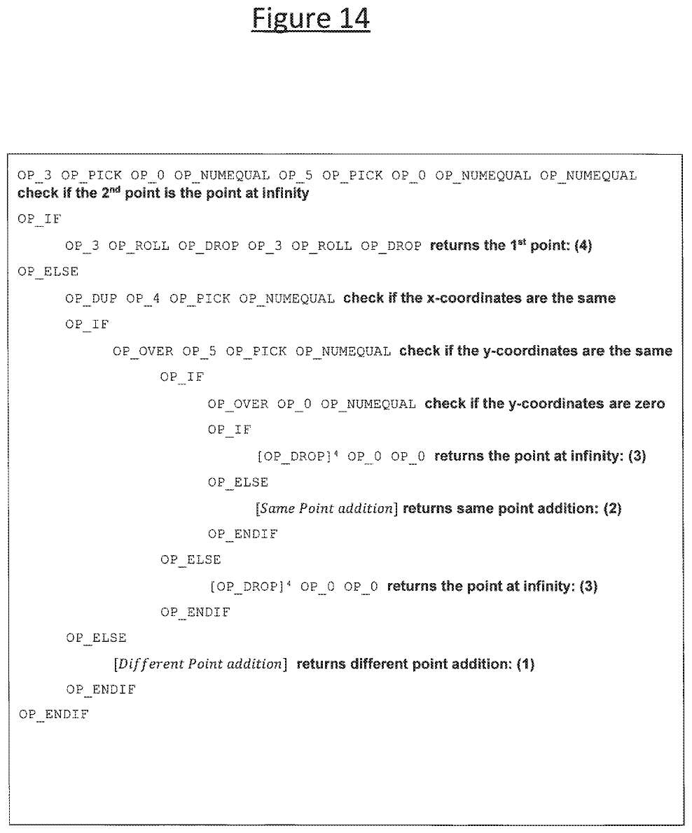

FIG. 14 illustrates another example script for performing a point addition. In this case, the example script performs a check of whether the two points to be added are the same point or different points, and the acts accordingly. Note that the bold text in FIG. 14 explain what that line of code is doing, and the numbers (i) correspond to the definition of point addition given above. The input is assumed to be in the form <y₂> <x₂> <y₁> <x₁>, where each coordinate is a 32-byte hexadecimal.

The first line is a check for the second point being <0x00> <0x00>, which in the chosen notation is the point at infinity, since it is known that this point is not on the secp256k1 curve. If the second point is the point at infinity, then the first point <y₁> <x₁> is returned to the stack, which corresponds to definition (4) of point addition. Note that in the example code, the point at infinity only ever appears as the second point.

Then the first line inside the first OP ELSE checks if the x-coordinates are equivalent. If they are, a check of whether the y-coordinates are also equivalent is performed. If it finds that they are, then a check of whether y=0 is performed, in which case the point at infinity is returned, which corresponds to definition (3) of point addition. If y≠0, then the code adds a point to itself, which is the function [Same Point addition] defined above, and corresponds to definition (2) of point addition definition. Next, if the y values are different, then the points must be inverse to each other, returning the point at infinity, so <0x00> <0x00> is returned. This corresponds to definition (3) of point addition. Finally, if the x values are different, the code executes different point addition [Different Point addition], corresponding to definition (1) of point addition.

This completes the calculation of point addition in script, and ultimately completes the calculation of child keys in script. The final state of the stack is now the following:

< P_{child}(x) >
< P_{child}(y) >

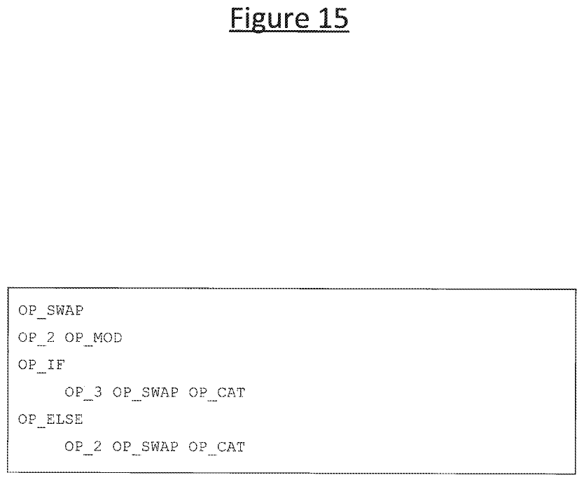

FIG. 15 illustrates an example script for converting the data on the stack into a compressed key format. The example function takes the x and y coordinate of a key as inputs, and returns the compressed public key format. For an input <P(y)> <P(x)>, the opcodes in FIG. 15 defines the function [Compressed Key format]. The first 3 opcodes check if the y coordinate of the child key is even or odd. Then the next opcodes append the x-coordinate with the correct prefix depending on this result. This results in the compressed child key, giving the final state of the stack to be the following:

< P_{child} >

Alternatively, if in fact the result is desired to be in uncompressed format, the following function may be used:

[Uncompressed Key format]=OP_SWAP OP_CAT<0x04> OP_SWAP OP_CAT.

### CONCLUSION

It will be appreciated that the above embodiments have been described by way of example only. More generally, there may be provided a method, apparatus or program in accordance with any one or more of the following Statements.

Statement 1. A computer-implemented method of generating a hash-based message authentication code, HMAC, of a message using blockchain transactions, wherein the method is performed by a first party and comprises: generating an output script of a first blockchain transaction, wherein the output script comprises a HMAC script configured to, when executed alongside an input script of a second blockchain transaction, generate the HMAC of the message based on an input value included in the input script of the second blockchain transaction; and causing the first blockchain transaction to be transmitted to one or more nodes of a blockchain network for inclusion in the blockchain.

The HMAC script may be configured to cause the HMAC of the message to be output to a memory store. For instance, the HMAC script may be written in a stack-based language, and may cause the HMAC to be output to a stack.

The message may be a plaintext message or a ciphertext message.

Statement 2. The method of statement 1, wherein the HMAC script comprises the message, wherein the input value is a HMAC key, and wherein the HMAC script is configured to generate the HMAC of the message based on the HMAC key included in the input script of the second blockchain transaction.

Statement 3. The method of statement 1, wherein the HMAC script comprises HMAC key, wherein the input value is the message, and wherein the HMAC script is configured to generate the HMAC of the message based on the message included in the input script of the second blockchain transaction.

Statement 4. The method of statement 1, wherein the HMAC script comprises HMAC key, wherein the input value is a hash of at least the HMAC key and the message, and wherein the HMAC script is configured to generate the HMAC of the message based on the hash of at least the HMAC key and the message included in the input script of the second blockchain transaction.

Statement 5. The method of any preceding statement, wherein the second blockchain transaction is generated by a second party, and wherein the method comprises transmitting the message to the second party.

Statement 6. The method of any preceding statement, wherein the message is an encryption of a plaintext message.

Statement 7. The method of any preceding statement, wherein the output script comprises a HMAC verification script, wherein the HMAC verification script comprises the HMAC script and a predetermined HMAC of the message, and wherein the HMAC verification script is configured to determine whether the predetermined HMAC of the message corresponds to the HMAC generated based on the input value included in the input script of the second blockchain transaction.

Statement 8. The method of statement 7, wherein the HMAC verification script is configured to, when executed alongside the input script of the second blockchain transaction, based on said determination of whether the predetermined HMAC of the message corresponds to the HMAC generated based on the input value, output a result indicating whether or not the predetermined HMAC corresponds to the HMAC generated based on the input value.

The HMAC verification script may be configured to output, to the memory store, e.g. the stack, the result indicating whether or not the predetermined HMAC corresponds to the HMAC generated based on the input value.

Statement 9. The method of statement 7 or statement 8, wherein the HMAC verification script is configured to, based on said determination of whether the predetermined HMAC of the message corresponds to the HMAC determined based on the input value, cause the second transaction to me marked as invalid if the predetermined HMAC does not correspond to the HMAC determined based on the input value.

Statement 10. The method of any preceding statement, wherein the output script of the first blockchain transaction comprises a public key derivation script, wherein the public key derivation script comprises the HMAC script, and wherein the public key derivation script is configured to, when executed alongside the input script of the second blockchain transaction, generate a new public key based on at least the determined HMAC of the message.

The public key derivation script may be configured to cause the new public key to be output to a memory store, e.g. the stack.

Statement 11. The method of statement 10, wherein the HMAC script comprises the message, the message comprising a previous public key, wherein the input value is a chain code, wherein the chain code defines a level, of the previous public key, in a hierarchy of levels of public keys, wherein the HMAC script is configured to generate the HMAC of the message based on the chain code included in the input script of the second blockchain transaction, and wherein the public key derivation script is configured to generate the new public key based on the previous public key and the HMAC generated based on the chain code.

Statement 12. The method of statement 10, wherein the HMAC script comprises a chain code, wherein the chain code defines a level of a previous public key in a hierarchy of levels of public keys, wherein the input value comprises the previous public key, and wherein the HMAC script is configured to generate the HMAC of the message based on the previous public key included in the input script of the second blockchain transaction, and wherein the public key derivation script is configured to generate the new public key based on the previous public key and the HMAC generated based on the previous public key.

Statement 13. The method of statement 10, wherein the HMAC script comprises a chain code, wherein the chain code defines a level of a previous public key in a hierarchy of levels of public keys, wherein the input value is a hash of at least the chain code and the message, the message comprising the previous public key, and wherein the HMAC script is configured to generate the HMAC of the message based on the hash of at least the chain code and the message in the input script of the second blockchain transaction, and wherein the public key derivation script is configured to generate the new public key based on the previous public key and the HMAC generated based on the previous public key.

Statement 14. The method of any of statements 11 to 13, wherein each level in the hierarchy of levels of public keys comprises a sequence of one or more public keys, and wherein the message comprises the previous public key and an index, wherein the index defines a position of the previous public key within the respective sequence of public keys in the respective level of the previous public key.

Statement 15. The method of statement 14 when dependent on statement 12 or statement 13, wherein the input value comprises the index.

Statement 16. Computer equipment comprising: memory comprising one or more memory units; and processing apparatus comprising one or more processing units, wherein the memory stores code arranged to run on the processing apparatus, the code being configured so as when on the processing apparatus to perform the method of any of statements 1 to 15.

Statement 17. A computer program embodied on computer-readable storage and configured so as, when run on computer equipment of statement 16, to perform the method of any of statements 1 to 15.

Statement 18. A first blockchain transaction comprising an output script, wherein the output script comprises a hash-based message authentication code, HMAC, script configured to, when executed alongside an input script of a second blockchain transaction, generate the HMAC of a message based on an input value included in the input script of the second blockchain transaction.

Statement 19. A computer-readable storage medium having stored thereon the first blockchain transaction of statement 18.

According to another aspect disclosed herein, there may be provided a method comprising the actions of the first party and the second party. The method may also include the actions of the network of nodes.

According to another aspect disclosed herein, there may be provided a system comprising the computer equipment of the first party and the computer equipment of the second party. The system may also comprise the computer equipment of the network of nodes.

According to another aspect disclosed herein, there may be provided a set of transactions comprising the first blockchain transaction and the second blockchain transaction.

Other variants or use cases of the disclosed techniques may become apparent to the person skilled in the art once given the disclosure herein. The scope of the disclosure is not limited by the described embodiments but only by the accompanying claims.

1. A computer-implemented method of generating a hash-based message authentication code (HMAC) of a message using blockchain transactions, wherein the method is performed by a first party and comprises:
generating an output script of a first blockchain transaction, wherein the output script comprises a HMAC script configured to, when executed alongside an input script of a second blockchain transaction, generate the HMAC of the message based on an input value included in the input script of the second blockchain transaction; and
causing the first blockchain transaction to be transmitted to one or more nodes of a blockchain network for inclusion in the blockchain.

2. The method of claim 1, wherein the HMAC script comprises the message, wherein the input value is a HMAC key, and wherein the HMAC script is configured to generate the HMAC of the message based on the HMAC key included in the input script of the second blockchain transaction.

3. The method of claim 1, wherein the HMAC script comprises a HMAC key, wherein the input value is the message, and wherein the HMAC script is configured to generate the HMAC of the message based on the message included in the input script of the second blockchain transaction.

4. The method of claim 1, wherein the HMAC script comprises a HMAC key, wherein the input value is a hash of at least the HMAC key and the message, and wherein the HMAC script is configured to generate the HMAC of the message based on the hash of at least the HMAC key and the message included in the input script of the second blockchain transaction.

5. The method of claim 1, wherein the second blockchain transaction is generated by a second party, and wherein the method comprises transmitting the message to the second party.

6. The method of claim 1, wherein the message is an encryption of a plaintext message.

7. The method of claim 1, wherein the output script comprises a HMAC verification script, wherein the HMAC verification script comprises the HMAC script and a predetermined HMAC of the message, and wherein the HMAC verification script is configured to determine whether the predetermined HMAC of the message corresponds to the HMAC generated based on the input value included in the input script of the second blockchain transaction.

8. The method of claim 7, wherein the HMAC verification script is configured to, when executed alongside the input script of the second blockchain transaction, based on said determination of whether the predetermined HMAC of the message corresponds to the HMAC generated based on the input value, output a result indicating whether or not the predetermined HMAC corresponds to the HMAC generated based on the input value.

9. The method of claim 7, wherein the HMAC verification script is configured to, based on said determination of whether the predetermined HMAC of the message corresponds to the HMAC determined based on the input value, cause the second transaction to me marked as invalid if the predetermined HMAC does not correspond to the HMAC determined based on the input value.

10. The method of claim 1, wherein the output script of the first blockchain transaction comprises a public key derivation script, wherein the public key derivation script comprises the HMAC script, and wherein the public key derivation script is configured to, when executed alongside the input script of the second blockchain transaction, generate a new public key based on at least the determined HMAC of the message.

11. The method of claim 10, wherein the HMAC script comprises the message, the message comprising a previous public key, wherein the input value is a chain code, wherein the chain code defines a level, of the previous public key, in a hierarchy of levels of public keys, wherein the HMAC script is configured to generate the HMAC of the message based on the chain code included in the input script of the second blockchain transaction, and wherein the public key derivation script is configured to generate the new public key based on the previous public key and the HMAC generated based on the chain code.

12. The method of claim 10, wherein the HMAC script comprises a chain code, wherein the chain code defines a level of a previous public key in a hierarchy of levels of public keys, wherein the input value comprises the previous public key, and wherein the HMAC script is configured to generate the HMAC of the message based on the previous public key included in the input script of the second blockchain transaction, and wherein the public key derivation script is configured to generate the new public key based on the previous public key and the HMAC generated based on the previous public key.

13. The method of claim 10, wherein the HMAC script comprises a chain code, wherein the chain code defines a level of a previous public key in a hierarchy of levels of public keys, wherein the input value is a hash of at least the chain code and the message, the message comprising the previous public key, and wherein the HMAC script is configured to generate the HMAC of the message based on the hash of at least the chain code and the message in the input script of the second blockchain transaction, and wherein the public key derivation script is configured to generate the new public key based on the previous public key and the HMAC generated based on the previous public key.

14. The method of claim 11, wherein each level in the hierarchy of levels of public keys comprises a sequence of one or more public keys, and wherein the message comprises the previous public key and an index, wherein the index defines a position of the previous public key within the respective sequence of public keys in the respective level of the previous public key.

15. The method of claim 14, wherein the HMAC script comprises the chain code, wherein the input value comprises the index.

16. Computer equipment, comprising:
memory comprising one or more memory units; and
processing apparatus comprising one or more processing units, wherein the memory stores code arranged to run on the processing apparatus, the code being configured so as when run on the processing apparatus, the processing apparatus performs a method of generating a hash-based message authentication code (HMAC) of a message using blockchain transactions, wherein the method is performed by a first party and comprises:
generating an output script of a first blockchain transaction, wherein the output script comprises a HMAC script configured to, when executed alongside an input script of a second blockchain transaction, generate the HMAC of the message based on an input value included in the input script of the second blockchain transaction; and
causing the first blockchain transaction to be transmitted to one or more nodes of a blockchain network for inclusion in the blockchain.

17. A computer program product embodied on a non-transitory computer-readable storage and configured so as, when run on computer equipment of claim 16, the computer equipment performs a method of generating a hash-based message authentication code (HMAC) of a message using blockchain transactions, wherein the method is performed by a first party and comprises:
generating an output script of a first blockchain transaction, wherein the output script comprises a HMAC script configured to, when executed alongside an input script of a second blockchain transaction, generate the HMAC of the message based on an input value included in the input script of the second blockchain transaction; and
causing the first blockchain transaction to be transmitted to one or more nodes of a blockchain network for inclusion in the blockchain.

18-19. (canceled)
